(19) United States
(12) Patent Application Publication
(10) Pub. No.: US 2004/0242456 A1
(43) Pub. Date: Dec. 2, 2004

(54) Herbicidal n-alkysulfonamino derivatives

(76) Inventors: Christoph Luthy, Basel (CH); Andrew Edmunds, Basel (CH); Roger Graham Hall, Basel (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/488,562

(22) PCT Filed: Sep. 5, 2002
(86) PCT No.: PCT/EP02/09963

(30) Foreign Application Priority Data
Sep. 6, 2001 (CH) 1656/01

(51) Int. Cl. A01N 41/06; A01N 43/40; A01N 43/80

(52) U.S. Cl. 514/1

(57) ABSTRACT

The present invention relates to novel, herbicidally active N-alkylsulfonamino derivatives of Formula (I), wherein the substituents are as defines in claim 1, to processes for their preparation, to compositions comprising those compounds, and to their use in controlling weeds, especially in crops of useful plants, or in inhibiting plant growth.

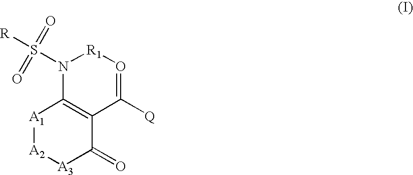

The present invention relates to novel, herbicidally active N-alkylsulfonamino derivatives, to processes for their preparation, to compositions comprising those compounds, and to their use in controlling weeds, especially in crops of useful plants, or in inhibiting plant growth.

N-Alkylsulfonamino derivatives having herbicidal action are disclosed, for example, in WO 00/15615, WO 00/39094 and WO 01/66522. Novel N-alkylsulfonamino derivatives having herbicidal and plant-growth-inhibiting properties have now been found.

The present invention accordingly relates to compounds of formula I

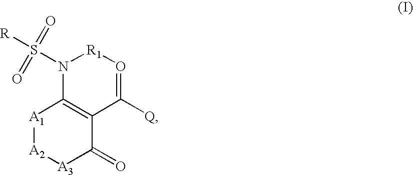

wherein

Q is a phenyl group substituted from one to four times by identical or different R₂ substituents, it also being possible for the phenyl group to contain a further fused-on, monocyclic or bicyclic, saturated, partially saturated or unsaturated, 5- to 8-membered ring system which may be interrupted once, twice or three times by —O—, —NR₁₀—, —S(O)p- or by —C(X₂)— and may be substituted from one to three times by identical or different R₁₁ substituents;

or Q is a pyridyl, pyridyl-N-oxido or pyrimidinyl group substituted from one to three times by identical or different R₂ substituents or is a 5-membered heteroaryl group substituted from one to three times by identical or different R₂ substituents;

A₁ is C(R₃R₄) or NR₂₁;

A₂ is C(R₅R₆)ₘ, C(O), oxygen, NR₇ or S(O)q;

A₃ is C(R₈R₉) or NR₂₂;

with the proviso that A₂ is other than S(O)q when A₁ is NR₂₁ and/or A₃ is NR₂₂;

m is 1 or 2;

n, p, q, r, s, t, u, v and w are each independently of the others 0, 1 or 2;

R is C₁-C₁₂alkyl, C₁-C₁₂haloalkyl, C₂-C₁₂alkenyl, C₂-C₁₂haloalkenyl, C₁-C₂alkoxycarbonyl- or phenyl-substituted vinyl; C₂-C₁₂alkynyl, C₂-C₁₂haloalkynyl, C₃-C₁₂allenyl, C₃-C₆cycloalkyl, C₃-C₆cycloalkyl-C₁-C₃alkyl, C₁-C₄alkoxy-C₁-C₁₂alkyl, C₁-C₄alkylthio-C₁-C₁₂alkyl, C₁-C₄alkyl-sulfinyl-C₁-C₁₂alkyl, C₁-C₄alkylsulfonyl-C₁-C₁₂alkyl, cyano-C₁-C₁₂alkyl, hydroxy-C₁-C₁₂alkyl, C₁-C₆alkylcarbonyloxy-C₁-C₁₂alkyl, C₁-C₄alkoxycarbonyl-C₁-C₁₂alkyl, C₁-C₄alkoxycarbonyloxy-C₁-C₁₂alkyl, rhodano-C₁-C₁₂alkyl, benzoyloxy-C₁-C₁₂alkyl, C₁-C₄alkylamino-C₁-C₁₂alkyl, di(C₁-C₄alkyl)amino-C₁-C₁₂alkyl, C₁-C₁₂alkylthiocarbonyl-C₁-C₁₂alkyl, formyl-C₁-C₁₂alkyl, phenyl-C₁-C₃alkylene which may be interrupted by oxygen or by —S(O)s-, or is NR₁₃R₁₄ or phenyl, it being possible for phenyl and the phenyl-containing radicals to be substituted in each case from one to five times by C₁-C₄alkyl, C₂-C₄alkenyl, C₁-C₄haloalkyl, C₁-C₄alkoxy, C₁-C₄haloalkoxy, halogen, S(O)ᵣR₁₅, S(O)₂NR₁₆R₁₇, cyano, C₁-C₄alkoxycarbonyl, C₁-C₄alkylcarbonyl, cyclopropylcarbonyl or by nitro;

or R is a five- or six-membered monocyclic or annellated bicyclic ring system, which may be aromatic, partially saturated or fully saturated and may contain from 1 to 3 hetero atoms selected from nitrogen, oxygen and sulfur, the ring system being bonded to the sulfur atom of the group —SO₂N(R₁)— either directly by a carbon atom or a nitrogen atom or by way of a C₁-C₃alkylene chain which may be interrupted by oxygen or by —S(O)s-, each ring system containing no more than 2 oxygen atoms and no more than two sulfur atoms, and it being possible for each ring system itself to be substituted from one to three times by C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, C₁-C₆haloalkoxy, C₃-C₆alkenyloxy, C₃-C₆alkynyloxy, mercapto, C₁-C₆alkylthio, C₁-C₆halo-alkylthio, C₂-C₆alkenylthio, C₂-C₆haloalkenylthio, C₂-C₆alkynylthio, C₁-C₃alkoxy-C₁-C₃alkylthio, C₁-C₄alkylcarbonyl-C₁-C₃alkylthio, C₁-C₄alkoxycarbonyl-C₁-C₃alkylthio, cyano-C₁-C₃alkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₂alkyl)aminosulfonyl, R₂₀—C₁-C₃alkylene (wherein the alkylene chain may be interrupted by oxygen or by —S(O)t-), di(C₁-C₄alkyl)amino, halogen, cyano, nitro or by phenyl, it being possible for phenyl itself to be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring do not contain halogen;

R₁ is C₁-C₆alkyl, C₂-C₆alkenyl, C₂-C₆alkynyl, C₁-C₆haloalkyl, C₂-C₆haloalkenyl, C₂-C₆halo-alkynyl, C₁-C₄alkoxy-C₁-C₂alkyl, C₁-C₄alkylcarbonyloxy-C₁-C₆alkyl, C₁-C₄alkoxycarbonyl-C₁-C₄alkyl, phenyl or benzyl, it being possible for the phenyl-containing groups to be substituted one or more times by halogen, C₁-C₄alkyl, C₁-C₂haloalkyl, C₁-C₂alkoxy, C₁-C₂haloalkoxy or by nitro;

or R₁ forms, together with R, a 4- to 7-membered ring which may be substituted by C₁-C₃-alkyl or may be interrupted by —O—, —NR₂₃—, —S(O)u- or by —C(X₁)—;

with the proviso that R₁ is other than C₁-C₆alkyl when Q is a phenyl, pyridyl or pyridyl-N-oxido group;

each R₂ independently is hydrogen, halogen, C₁-C₆alkyl, C₁-C₆haloalkyl, C₂-C₆alkenyl, C₂-C₆haloalkenyl, C₂-C₆alkynyl, C₂-C₆haloalkynyl, C₃-C₆cycloalkyl, C₁-C₆alkoxy, C₁-C₆haloalkoxy, C₃-C₆alkenyloxy, C₃-C₆alkynyloxy, C₁-C₆alkylthio, C₁-C₆alkylsulfinyl, C₁-C₆alkylsulfonyl, C₁-C₆haloalkylthio, C₁-C₆haloalkylsulfinyl, C₁-C₆haloalkylsulfonyl, C₁-C₆alkoxycarbonyl, C₁-C₆alkylcarbonyl, C₁-C₆alkylamino, di(C₁-C₆alkyl)amino, C₁-C₆alkylaminosulfonyl, di(C₁-C₆alkyl)aminosulfonyl, —N(R₁₈)—SO₂—R₁₉, nitro, cyano, hydroxy, amino, formyl, hydroxy-C₁-C₆alkyl, C₁-C₆alkoxy-C₁-C₆alkyl, C₁-C₆haloalkoxy-C₁-C₆alkyl, C₁-C₆alkylcarbonyloxy-C₁-C₄alkyl, C₁-C₆alkoxycarbonyloxy-C₁-C₆alkyl, C₁-C₆alkylthio-C₁-C₆alkyl, C_{l-C}₆alkylsulfinyl-C₁-C₆alkyl, C₁-C₆alkylsulfonyl-C₁-C₆alkyl, rhodano-C₁-C₆alkyl, cyano-C₁-C₆alkyl, C₃-C₆alkenyloxy-C₁-C₃alkyl, C₃-C₆alkynyloxy-C₁-C₃alkyl, C₁-C₆alkoxy-C₁-C₆alkoxy-C₁-C₃alkyl, C₁-C₆haloalkoxy-C₁-C₆alkoxy-C₁-C₆alkyl, C₁-C₄alkoxy-C₁-C₄alkoxy-C₁-C₄alkoxy-C₁-C₃alkyl, C₁-C₄alkoxy-C₁-C₄alkoxy-C₁-C₄alkoxy-C₁-C₄alkoxy-C₁-C₃alkyl, C₁-C₈alkylcarbonyloxy-C₁-C₄alkoxy-C₁-C₄alkyl, C₁-C₆alkoxy-C₁-C₆alkoxy, C₁-C₆alkoxycarbonyloxy-C₁-C₆alkoxy, cyano-C₁-C₆alkoxy, cyano-C₁-C₆alkenyloxy, C₁-C₆alkoxycarbonyl-C₁-C₆alkoxy-C₁-C₃alkyl, C₁-C₆alkoxycarbonyl-C₁-C₆alkoxy, C₁-C₆alkylthio-C₁-C₆alkoxy, C₁-C₆alkylthio-C_{1-C}₆alkoxy-C₁-C₃alkyl, C₁-C₆alkoxycarbonyl-C₁-C₆alkylthio, C₁-C₆alkoxycarbonyl-C₁-C₆alkylthio-C₁-C₃alkyl, C₁-C₆alkoxycarbonyl-C₁-C₆alkylsulfinyl, C₁-C₆alkoxycarbonyl-C₁-C₆alkylsulfinyl-C₁-C₃alkyl, C₁-C₆alkoxycarbonyl-C₁-C₆alkylsulfonyl, C₁-C₆alkoxycarbonyl-C₁-C₆alkylsulfonyl-C₁-C₃alkyl, R₂₅SO₂N(R₂₄)—C₁-C₃alkyl, C₁-C₆alkylsulfonyloxy, C₁-C₆haloalkylsulfonyloxy, phenyl, benzyl, phenoxy, phenylthio, phenylsulfinyl, phenylsulfonyl, benzylthio, benzylsulfinyl or benzylsulfonyl, it being possible for the phenyl-containing groups to be substituted once, twice or three times by C₁-C₆alkyl, C₁-C₆haloalkyl, C₂-C₆alkenyl, C₂-C₆haloalkenyl, C₂-C₆-alkynyl, C₂-C₆haloalkynyl, C₁-C₆alkoxy, C₁-C₆haloalkoxy, C₃-C₆alkenyloxy, C₃-C₆alkynyloxy, C₁-C₆alkylthio, C₁-C₆haloalkylthio, C₃-C₆alkenylthio, C₃-C₆haloalkenylthio, C₃-C₆alkynylthio, C₁-C₄alkoxy-C₁-C₃alkylthio, C₁-C₄alkylcarbonyl-C₁-C₃alkylthio, C₁-C₄alkoxycarbonyl-C₁-C₃alkylthio, cyano-C₁-C₃alkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₄alkyl)aminosulfonyl, C₁-C₃alkoxy-C₁-C₃alkyl, C₁-C₃alkoxycarbonyl-C₁-C₃alkyl, C₁-C₃alkylthio-C₁-C₃alkyl, C₁-C₃alkylsulfinyl-C₁-C₃alkyl, C₁-C₃alkylsulfonyl-C₁-C₃alkyl, NR₁₃R₁₄, halogen, cyano, nitro, phenyl or by phenyl-C₁-C₃alkyl which may be interrupted in the alkyl chain by oxygen or by —S(O)t-, and it being possible for phenyl-group-containing substituents themselves to be substituted on the phenyl ring by C₁-C₃alkyl, C₁-C₃haloalkyl, C₁-C₃alkoxy, C₁-C₃haloalkoxy, halogen, cyano or by nitro,

or R₂ is C₃-C₆cycloalkyl or phenyl, which is bonded to the group Q either directly or by way of a C₁-C₄alkylene chain which may be interrupted by oxygen or by —S(O)t-, it being possible for cycloalkyl to be substituted by C₁-C₃alkyl or by halogen and for phenyl to be substituted by C₁-C₃alkyl, C₁-C₃haloalkyl, C₁-C₃alkoxy, C₁-C₃haloalkoxy, halogen, cyano or by nitro;

or R₂ is a five- to ten-membered monocyclic or annellated bicyclic ring system which may be aromatic, partially saturated or fully saturated and may contain from 1 to 4 hetero atoms selected from nitrogen, oxygen and sulfur, or may be interrupted by a carbonyl group; the ring system being bonded to the group Q either directly or by way of a C₁-C₄alkylene chain which may be interrupted by oxygen or —S(O)t-, and wherein each ring system may contain no more than 2 oxygen atoms and no more than two sulfur atoms, and it being possible for the ring system itself to be substituted once, twice or three times by halogen, C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, C₁-C₆haloalkoxy, C₃-C₆alkenyloxy, C₃-C₆alkynyloxy, C₁-C₆alkylthio, C₁-C₆haloalkylthio, C₃-C₆alkenylthio, C₃-C₆haloalkenylthio, C₃-C₆alkynylthio, C₂-C₅alkoxyalkylthio, C₃-C₅acetylalkylthio, C₃-C₆alkoxycarbonylalkylthio, C₂-C₄cyanoalkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₄alkylaminosulfonyl, di(C₁-C₄alkyl)aminosulfonyl, R₂₀—C₁-C₃alkylene (wherein the alkylene chain may be interrupted by oxygen or by —S(O)t-), NR₁₃R₁₄, halogen, cyano, nitro or by phenyl, it being possible for phenyl itself to be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring do not contain halogen;

R₃ and R₈ are each independently of the other hydrogen, C₁-C₆alkyl, C₂-C₆alkenyl, C₂-C₆-alkynyl, C₁-C₆alkoxy, C₁-C₆alkyl-S(O)r-, C₁-C₆alkoxycarbonyl, C₁-C₆alkylcarbonyl, C₁-C₆alkyl-NHS(O)₂, C₁-C₆alkylamino, di(C₁-C₆alkyl)amino, hydroxy, C₁-C₆alkoxy, C₃-C₆alkenyloxy, C₃-C₆alkynyloxy, hydroxy-C₁-C₆alkyl, C₁-C₄alkylsulfonyloxy-C₁-C₆alkyl, tosyloxy-C₁-C₆alkyl, halogen, cyano, nitro, phenyl, or phenyl substituted by C₁-C₄alkyl, C₁-C₄haloalkyl, C₁-C₄-alkoxy, C₁-C₄haloalkoxy, C₁-C₄alkylcarbonyl, C₁-C₄alkoxycarbonyl, amino, C₁-C₄alkylamino, di(C₁-C₄alkyl)amino, C₁-C₄alkylthio, C₁-C₄alkylsulfinyl, C₁-C₄alkylsulfonyl, C₁-C₄alkylsulfonyloxy, C₁-C₄haloalkylthio, C₁-C₄haloalkylsulfinyl, C₁-C₄haloalkylsulfonyl, C₁-C₄haloalkylsulfonyloxy, C₁-C₄alkylsulfonylamino, N—(C₁-C₄alkyl)-C₁-C₄alkylsulfonylamino, halogen, nitro, COOH or by cyano;

or, when A₂ is C(R₅R₆)ₘ, R₈ forms, together with R₃, a direct bond or a C₁-C₃alkylene bridge;

R₄ and R₉ are each independently of the other hydrogen, C₁-C₄alkyl or C₁-C₄alkyl-S(O)r-;

or R₄ together with R₃, and/or R₉ together with R₈ are a C₂-C₆alkylene bridge which may be interrupted by —O— and/or —C(O)—, or by —S(O)v-;

R₅ is hydrogen, hydroxy, C₁-C₆alkyl, C₁-C₆haloalkyl, C₁-C₄hydroxyalkyl, C₁-C₄alkoxy-C₁-C₄alkyl, C₁-C₄alkylthio-C₁-C₄alkyl, C₁-C₄alkylthio-C₃-C₆cycloalkyl, C₁-C₄alkylcarbonyloxy-C₁-C₄alkyl, C₁-C₄alkylsulfonyloxy-C₁-C₄alkyl, tosyloxy-C₁-C₄alkyl, di(C₁-C₄alkoxy)-C₁-C₄alkyl, C₁-C₄alkoxycarbonyl, di(C₁-C₃alkylthio)-C₁-C₄alkyl, (C₁-C₃alkoxy)-(C₁-C₃alkylthio)-C₁-C₄alkyl, C₃-C₅oxacycloalkyl, C₃-C₅thiacycloalkyl, C₃-C₄dioxacycloalkyl, C₃-C₄dithiacycloalkyl, C₃-C₄-oxathiacycloalkyl, formyl, C₁-C₄alkoxyiminomethylene, carbamoyl, C₁-C₄alkylaminocarbonyl, di(C₁-C₄alkyl)aminocarbonyl, phenylaminocarbonyl, benzylaminocarbonyl or phenyl, it being possible for the phenyl-containing groups themselves to be substituted by C₁-C₄alkyl, C₁-C₄haloalkyl, C₁-C₄alkoxy, C₁-C₄haloalkoxy, C₁-C₄alkylcarbonyl, C₁-C₄alkoxycarbonyl, amino, C₁-C₄alkylamino, di(C₁-C₄alkyl)amino, C₁-C₄alkylthio, C₁-C₄alkylsulfinyl, C₁-C₄alkylsulfonyl, C₁-C₄alkylsulfonyloxy, C₁-C₄haloalkylthio, C₁-C₄haloalkylsulfinyl, C₁-C₄haloalkylsulfonyl, C₁-C₄haloalkylsulfonyloxy, C₁-C₄alkylsulfonylamino, N—(C₁-C₄alkyl)-C₁-C₄alkylsulfonylamino, halogen, nitro, COOH or by cyano;

or R₅ forms, together with R₃, R₄, R₈ or R₉, a direct bond or a C₁-C₄alkylene bridge or, when

m is 2, two groups R₅ together may be a direct bond;

R₆ is hydrogen, C₁-C₄alkyl or C₁-C₄haloalkyl;

R₇ is hydrogen, C₁-C₆alkyl, C₁-C₆haloalkyl, C₁-C₄alkoxycarbonyl, C₁-C₄alkylcarbonyl or di(C₁-C₄alkyl)aminocarbonyl, or phenyl which itself may be substituted by C₁-C₄alkyl, C₁-C₄haloalkyl, C₁-C₄alkoxy, C₁-C₄haloalkoxy, C₁-C₄alkylcarbonyl, C₁-C₄alkoxycarbonyl, C₁-C₄alkylamino, di(C₁-C₄alkyl)amino, C₁-C₄alkylthio, C₁-C₄alkylsulfinyl, C₁-C₄alkylsulfonyl, C₁-C₄alkylsulfonyloxy, C₁-C₄haloalkylthio, C₁-C₄haloalkylsulfinyl, Cₗ-C₄haloalkylsulfonyl, C₁-C₄haloalkylsulfonyloxy, C₁-C₄alkylsulfonylamino, N—(C₁-C₄alkyl)-C₁—C₄alkylsulfonylamino, halogen, nitro or by cyano;

R₁₀ and R₂₃ are each independently of the other hydrogen or C₁-C₆alkyl;

R₁₁ is halogen, C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, C₁-C₆haloalkoxy, C₃-C₆alkenyloxy, C₃-C₆alkynyloxy, C₁-C₆alkylthio, C₁-C₆haloalkylthio, C₃-C₆alkenylthio, C₃-C₆haloalkenylthio, C₃-C₆alkynylthio, C₁-C₄alkoxy-C₁-C₂alkylthio, C₁-C₄alkylcarbonyl-C₁-C₂alkylthio, C₁-C₄alkoxycarbonyl-C₁-C₂alkylthio, cyano-C₁-C₄alkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₄alkylaminosulfonyl, di(C₁-C₄alkyl)aminosulfonyl, R₂₀—C₁-C₃alkylene (wherein the alkylene chain may be interrupted by oxygen or by —S(O)t-), NR₁₃R₁₄, halogen, cyano, nitro or phenyl, it being possible for phenyl itself to be substituted on the phenyl ring once, twice or three times by C₁-C₃alkyl, C₁-C₃haloalkyl, C₁-C₃alkoxy, C₁-C₃haloalkoxy, halogen, cyano or by nitro;

X₁ and X₂ are each independently of the other oxygen, di-C₁-C₄alkoxy or NR₁₂;

R₁₂ is hydroxy or C₁-C₄alkoxy;

R₁₃, R₁₄, R₁₅, R₁₆ and R₁₇ are each independently of the others C₁-C₁₂alkyl;

or R₁₃ and R₁₄ and/or R₁₆ and R₁₇, together with the nitrogen atom to which they are bonded, form a 3- to 7-membered ring which may be interrupted by —O—, —NR₇ or by —S(O)w-;

R₁₈ and R₂₄ are each independently of the other hydrogen, C₁-C₆alkyl, C₂-C₆alkenyl, C₂-C₆alkynyl, C₁-C₆haloalkyl, C₁-C₄alkoxy-C₁-C₂alkyl, phenyl or benzyl, it being possible for the phenyl-containing radicals to be substituted one or more times by halogen, C₁-C₄alkyl, C₁-C₂haloalkyl, C₁-C₂alkoxy, C₁-C₂haloalkoxy or by nitro;

or R₁₈ together with R₁₉ or R₂₄ together with R₂₅ form a 4- to 7-membered ring which may be substituted by C₁-C₃alkyl or interrupted by —O—, —NR₂₃—, —S(O)u- or by —C(X₁)—;

R₁₉ and R₂₅ are each independently of the other as defined for R;

R₂₀ is C₁-C₆alkoxy, C₁-C₃alkoxy-C₁-C₃alkoxy, C₁-C₄alkoxycarbonyl, C₁-C₆alkylthio, C₁-C₆alkylsulfinyl, C₁-C₆alkylsulfonyl or phenyl, it being possible for phenyl to be substituted by C₁-C₃alkyl, C₁-C₃haloalkyl, C₁-C₃alkoxy, C₁-C₃haloalkoxy, halogen, cyano or by nitro;

R₂₁ and R₂₂ are each independently of the other hydrogen, C₁-C₆alkyl, C₁-C₆haloalkyl, C₃-C₆alkenyl, C₃-C₆alkynyl, C₁-C₆alkoxy, benzyl or phenyl, it being possible for benzyl or phenyl itself to be substituted by C₁-C₄alkyl, C₁-C₄haloalkyl, C₁-C₄alkoxy, C₁-C₄haloalkoxy, C₁-C₄alkylcarbonyl, C₁-C₄alkoxycarbonyl, C₁-C₄alkylthio, C₁-C₄alkylsulfinyl, C₁-C₄alkylsulfonyl, C₁-C₄haloalkylthio, C₁-C₄haloalkylsulfinyl, C₁-C₄haloalkylsulfonyl, halogen, nitro or by cyano;

and to the agrochemically acceptable salts and all stereoisomers and tautomers of the compounds of formula I.

The alkyl groups appearing in the definitions of substituents may be straight-chain or branched and are, for example, methyl, ethyl, n-propyl, isopropyl, n-butyl, sec-butyl, isobutyl, tert-butyl, pentyl, hexyl, heptyl, octyl, nonyl, decyl, undecyl and dodecyl and branched isomers thereof. Alkoxy, alkenyl and alkynyl radicals are derived from the mentioned alkyl radicals. The alkenyl and alkynyl groups can be mono- or poly-unsaturated, as a result of which C₂-C₁₂alkyl chains having one or more double or triple bonds are included. Alkenyl is, for example, vinyl, allyl, isobuten-3-yl, CH₂═CH—CH₂13 CH═CH₂13 , CH₂═CH—CH₂—CH₂—CH═CH₂— or CH₃—CH═CH—CH₂—CH═CH—; alkynyl is, for example, propargyl and allenyl is CH₂═C═CH₂—.

An alkylene chain may be substituted by one or more C₁-C₃alkyl groups, especially methyl groups; such alkylene chains and alkylene groups are preferably unsubstituted. The same is also true for all groups containing C₃-C₆cycloalkyl, C₃-C₅oxacycloalkyl, C₃-C₅thiacycloalkyl, C₃-C₄dioxacycloalkyl, C₃-C₄dithiacycloalkyl and C₃-C₄oxathiacycloalkyl.

A C₁-C₃— and C₁-C₄-alkylene chain which may be interrupted by oxygen or —S(O)s- or by —S(O)t- is understood to be, for example, —CH₂—, —CH₂O—, —OCH₂—, —CH₂OCH₂—, —OCH₂CH₂—, —OCH₂CH₂CH₂— or —CH₂SCH₂—. The expression R₂₀—C₁-C₃alkylene which may be interrupted by oxygen or by —S(O)t- includes, for example, CH₃OCH₂CH₂O—, benzylthio and benzyloxymethyl.

Halogen is generally fluorine, chlorine, bromine or iodine, preferably fluorine or chlorine. The equivalent is also true for halogen in conjunction with other groups, for example haloalkyl, haloalkoxy or halophenyl.

Haloalkyl groups having a chain length of from 1 to 6 carbon atoms are, for example, fluoromethyl, difluoromethyl, trifluoromethyl, chloromethyl, dichloromethyl, trichloromethyl, 2,2,2-trifluoroethyl, 1-fluoroethyl, 2-fluoroethyl, 2-chloroethyl, 2-fluoro-prop-2-yl, pentafluoroethyl, 1,1-difluoro-2,2,2-trichloroethyl, 2,2,3,3-tetrafluoroethyl, 2,2,2-trichloroethyl, pentafluoroethyl, heptafluoro-n-propyl and perfluoro-n-hexyl. Preferred haloalkyl groups in the meanings of R to Rₓ, and especially for at least one group R₂ when Q is a pyridyl or pyridyl-N-oxido group, are fluoromethyl, difluoromethyl, difluorochloromethyl, trifluoromethyl and pentafluoroethyl.

As haloalkenyl, mono- or poly-halo-substituted alkenyl groups are suitable, the halogen being fluorine, chlorine, bromine or iodine, especially fluorine or chlorine, for example 1-chlorovinyl, 2-chlorovinyl, 2,2-difluorovinyl, 2,2-difluoroprop-1-en-2-yl, 2,2-dichlorovinyl, 3-fluoroprop-1-enyl, chloroprop-1-en-1-yl, 3-bromoprop-1-en-1-yl, 2,3,3-trifluoroprop-2-en-1-yl, 2,3,3-trichloroprop-2-en-1-yl and 4,4,4-trifluorobut-2-en-1-yl.

As haloalkynyl, mono- or poly-halo-substituted alkynyl groups, for example, are suitable, the halogen being bromine, iodine or, especially fluorine or chlorine, for example 3-fluoropropynyl, 3-chloropropynyl, 3-bromopropynyl, 3,3,3-trifluoropropynyl and 4,4,4-trifluorobut-2-yn-1-yl.

A C₃-C₆cycloalkyl group may likewise be mono- or poly-halo-substituted, for example 2,2-dichlorocyclopropyl, 2,2-dibromocyclopropyl, 2,2,3,3-tetrafluorocyclobutyl and 2,2-difluoro-3,3-dichlorocyclobutyl.

Alkoxy groups have preferably a chain length of from 1 to 6 carbon atoms. Alkoxy is, for example, methoxy, ethoxy, propoxy, isopropoxy, n-butoxy, isobutoxy, sec-butoxy and tert-butoxy, and also the pentyloxy and hexyloxy isomers; preferably methoxy and ethoxy.

Haloalkoxy groups have preferably a chain length of from 1 to 6 carbon atoms, for example fluoromethoxy, difluoromethoxy, trifluoromethoxy, 2,2,2-trifluoroethoxy, 1,1,2,2-tetrafluoro-ethoxy, 1-fluoroethoxy, 2-fluoroethoxy, 2-chloroethoxy, 2,2-difluoroethoxy and 2,2,2-trichloroethoxy, preferably fluoromethoxy, difluoromethoxy, 2-chloroethoxy and trifluoromethoxy.

Alkylthio groups have preferably a chain length of from 1 to 8 carbon atoms.

Alkylthio is, for example, methylthio, ethylthio, propylthio, isopropylthio, n-butylthio, isobutylthio, sec-butylthio and tert-butylthio, preferably methylthio and ethylthio.

Alkylsulfinyl is, for example, methylsulfinyl, ethylsulfinyl, propylsulfinyl, isopropylsulfinyl, n-butylsulfinyl, isobutylsulfinyl, sec-butylsulfinyl, tert-butylsulfinyl, preferably methylsulfinyl and ethylsulfinyl.

Alkylsulfonyl is, for example, methylsulfonyl, ethylsulfonyl, propylsulfonyl, isopropylsulfonyl, n-butylsulfonyl, isobutylsulfonyl, sec-butylsulfonyl and tert-butylsulfonyl, preferably methylsulfonyl and ethylsulfonyl.

Alkylamino is, for example, methylamino, ethylamino, n-propylamino, isopropylamino or the butylamino isomers. Dialkylamino is, for example, dimethylamino, methylethylamino, diethylamino, n-propylmethylamino, dibutylamino and diisopropylamino. Preference is given to alkylamino groups having a chain length of from 1 to 4 carbon atoms.

Alkoxyalkyl groups have preferably from 2 to 6 carbon atoms. Alkoxyalkyl is, for example, methoxymethyl, methoxyethyl, ethoxymethyl, ethoxyethyl, n-propoxymethyl, n-propoxyethyl, isopropoxymethyl and isopropoxyethyl.

Alkoxyalkoxyalkyl groups have preferably from 3 to 8 carbon atoms, for example methoxymethoxymethyl, methoxyethoxymethyl, ethoxymethoxymethyl and ethoxyethoxymethyl.

Di(C₁-C₄alkoxy)-C₁-C₄alkyl is understood to be, for example, dimethoxymethyl and diethoxymethyl.

Alkylthioalkyl groups have preferably from 2 to 6 carbon atoms. Alkylthioalkyl is, for example, methylthiomethyl, methylthioethyl, ethylthiomethyl, ethylthioethyl, n-propylthiomethyl, n-propylthioethyl, isopropylthiomethyl, isopropylthioethyl, butylthiomethyl, butylthioethyl and butylthiobutyl.

Alkylcarbonyl is preferably acetyl or propionyl.

Alkoxycarbonyl is, for example, methoxycarbonyl, ethoxycarbonyl, propoxycarbonyl, isopropoxycarbonyl, n-butoxycarbonyl, isobutoxycarbonyl, sec-butoxycarbonyl and tert-butoxycarbonyl, preferably methoxycarbonyl, ethoxycarbonyl or tert-butoxycarbonyl.

Phenyl, including phenyl as part of a substituent such as phenoxy, benzyl, benzyloxy, benzoyl, phenylthio, phenylalkyl, phenoxyalkyl or tosyl, may be in mono- or poly-substituted form, in which case the substituents may be in the ortho-, meta- and/or para-position(s), as desired.

Q as a pyridyl group may be a 2-pyridyl, 3-pyridyl or 4-pyridyl group, with special emphasis being given to the 3-pyridyl group and the 3-pyridyl-N-oxide group. Q as a pyrimidinyl group can be a 2-, 4- or 5-pyrimidinyl group, with emphasis being given to the 5-pyrimidinyl group. Q as a substituted 5-membered heteroaryl group may be, for example, furyl, thienyl, pyrrolyl, pyrazolyl, imidazolyl, triazolyl, isoxazolyl, oxazolyl or thiazolyl.

A five- to ten-membered monocyclic or annellated bicyclic ring system which may be aromatic, partially saturated or fully saturated and may contain from 1 to 4 hetero atoms selected from nitrogen, oxygen and sulfur or a carbonyl group, and wherein each ring system may contain no more than 2 oxygen atoms and no more than two sulfur atoms is understood to be, for example, pyridyl, pyrimidinyl, triazinyl, pyrrolyl, pyrazolyl, triazolyl, tetrazolyl, thienyl, furyl, isoxazolyl, oxadiazolyl, thiazolyl, thiadiazolyl, 2-pyranyl, 1,3-dioxol-2-yl, oxiranyl, 3-oxetanyl, tetrahydrofuranyl, tetrahydropyranyl or the group

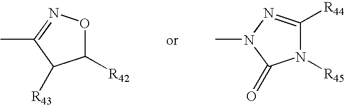

wherein R₄₂ and R₄₃ are each independently of the other preferably hydrogen, halogen, C₁-C₄alkyl; C₁-C₄haloalkyl, C₁-C₄alkoxy or C₁-C₄alkylthio or together are a C₁-C₄alkylene group; R₄₄ is especially hydrogen, halogen, C₁-C₄alkyl or C₁-C₄alkoxy; and R₄₅ is preferably hydrogen or C₁-C₄alkyl.

A further fused-on, monocyclic or bicyclic, saturated, partially saturated or unsaturated ring system, which is formed, for example, by two adjacent substituents R₂ of the phenyl, pyridyl or heteroaryl group Q, and which may be uninterrupted or interrupted one or more times by —O—, —NR₁₀—, —S(O)p- or by —C(X₂)— and unsubstituted or, in addition, substituted by one or more substituents R₁₁ is understood to be, for example, an annellated, bidentate ring system

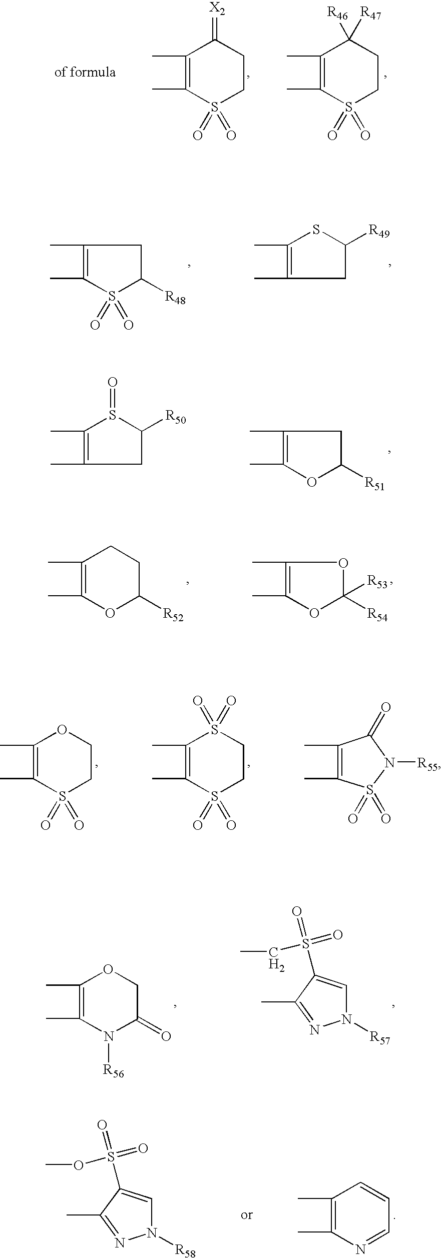

The substituents R₄₆ to R₅₈ therein are preferred meanings and positions of the substituents R₁₁, with, especially,

R₄₆ being hydrogen, halogen, C₁-C₄alkyl; C₁-C₄haloalkyl, C₁C₄alkoxy or C₁-C₄alkylthio;

R₄₇ being hydrogen, halogen, C₁-C₄alkyl or C₁-C₄alkoxy; and

R₅₀, R₅₁, R₅₂, R₅₄, R₅₅, R₅₆, R₅₇ and R₅₈ being hydrogen or C₁-C₄alkyl.

The invention relates also to the salts which the compounds of formula I are able to form with amines, alkali metal and alkaline earth metal bases or quaternary ammonium bases. Among the alkali metal and alkaline earth metal bases as salt formers, special mention should be made of the hydroxides of lithium, sodium, potassium, magnesium and calcium, especially the hydroxides of sodium and potassium. Examples of amines suitable for ammonium salt formation include ammonia as well as primary, secondary and tertiary C₁-C₁₈alkylamines, C₁-C₄hydroxyalkylamines and C₂-C₄alkoxyalkylamines, for example methylamine, ethylamine, n-propylamine, isopropylamine, the four butylamine isomers, n-amylamine, isoamylamine, hexylamine, heptylamine, octylamine, nonylamine, decylamine, pentadecylamine, hexadecylamine, heptadecylamine, octadecylamine, methyl-ethylamine, methyl-isopropylamine, methyl-hexylamine, methyl-nonylamine, methyl-pentadecylamine, methyl-octadecylamine, ethyl-butylamine, ethyl-heptylamine, ethyl-octylamine, hexyl-heptylamine, hexyl-octylamine, dimethylamine, diethylamine, di-n-propylamine, diisopropylamine, di-n-butylamine, di-n-amylamine, diisoamylamine, dihexylamine, diheptylamine, dioctylamine, ethanolamine, n-propanolamine, isopropanolamine, N,N-diethanolamine, N-ethylpropanolamine, N-butylethanolamine, allylamine, n-butenyl-2-amine, n-pentenyl-2-amine, 2,3-dimethylbutenyl-2-amine, dibutenyl-2-amine, n-hexenyl-2-amine, propylenediamine, trimethylamine, triethylamine, tri-n-propylamine, triisopropylamine, tri-n-butylamine, triisobutylamine, tri-sec-butylamine, tri-n-amylamine, methoxyethylamine and ethoxyethylamine; heterocyclic amines, for example pyridine, quinoline, isoquinoline, morpholine, piperidine, pyrrolidine, indoline, quinuclidine and azepine; primary arylamines, for example anilines, methoxyanilines, ethoxyanilines, o-, m- and p-toluidines, phenylene-diamines, naphthylamines and o-, m- and p-chloroanilines; but especially triethylamine, isopropylamine and diisopropylamine. Quaternary ammonium bases suitable for salt formation are, for example, [N(RₐR_{b}R_{c}R_{d})]⁺OH⁻ wherein Rₐ, R_{b}, R_{c} and R_{d} are each independently of the others C₁-C₄alkyl. Other suitable tetraalkylammonium bases with other anions can be obtained, for example, by anion exchange reactions. M⁺ is preferably an ammonium salt, especially NH₄⁺, or an alkali metal, especially potassium or sodium.

The compounds of formula I may, depending upon the preparation method, occur in various isomeric forms, which are shown in formulae la, lb, lc and ld, preference being given to formulae la and lb.

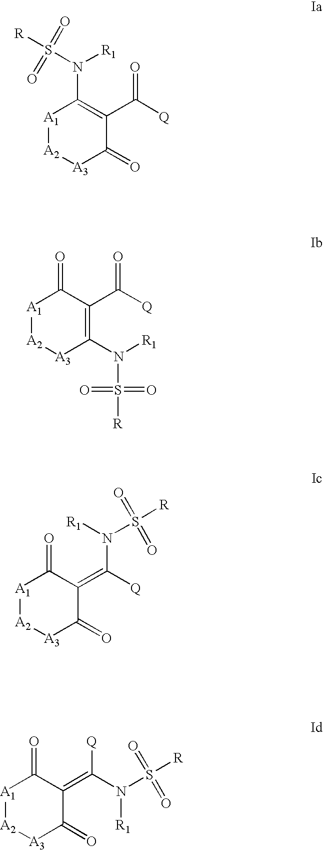

The present invention relates also to those isomeric and stereoisomeric forms of the compound of formula I.

Among the compounds of formula I, special preference is given to those groups wherein:

a) A₁ is CR₃R₄ and R₃ is hydrogen, methyl, ethyl, propargyl, methoxycarbonyl, ethoxycarbonyl, methylthio, methylsulfinyl or methylsulfonyl, and R₄ is hydrogen or methyl, or R₄ forms, together with R₃, an ethylene bridge;

b) A₂ is CR₅R₆ or an ethylene bridge —(CH₂)₂—, and R₅ is hydrogen, methyl or trifluoromethyl, and R₆ is hydrogen or methyl, or R₅ is, together with R₄ or R₉, a direct bond or a methylene bridge;

c) A₂ is C(O) and R₃, R₄, R₈ and R₉ are in each case methyl;

d) A₂ is oxygen and R₃, R₄, R₈ and R₉ are in each case methyl;

e) A₃ is CR₈R₉ and R₈ is hydrogen or methyl, and R₉ is hydrogen or methyl, or R₈ is, together with R₄, a methylene or ethylene bridge;

f) R is C₁-C₁₂alkyl, phenyl or benzyl;

g) R₁ is benzyl or C₁-C₄alkoxy-C₁-C₄alkyl, especially methoxyethyl or ethoxyethyl;

h) Q is phenyl which is substituted once, twice, three times or four times by R₂ and wherein at least one group R₂ is in the ortho-position relative to the carbonyl group —C(O)— to which Q is bonded;

i) Q is phenyl substituted twice or three times and R₂ in the 2-position is preferably methyl, trifluoromethyl, chlorine, bromine, methoxy, methoxymethyl, methylthio, methylsulfinyl, methylsulfonyl, cyano or nitro and in the 4-position is preferably trifluoromethyl, chlorine, bromine, cyano, nitro, methylsulfonyl, methylsulfonyloxy or methylsulfonylamino and, phenyl, where appropriate, may contain in 3-position relative to the substituent —C(O)-Q a further substituent as defined generally for R₂;

j) Q is a phenyl group wherein a group R₂ in the 2-position relative to the substituent —C(O)-Q is substituted by methyl, halomethyl, chlorine or by bromine, and in the 3,4-positions relative to the substituent —C(O)-Q is substituted by an annellated ring system such as, preferably, the bidentate groups —OCH₂O—, —S(O)pCH₂CH₂—, —S(O)pCH(CH₃)CH₂—, —CH₂CH₂CH₂S(O)p, —CH(CH₃)CH₂CH₂S(O)p-, —CH(OCH₃)CH₂CH₂S(O)p-, —C(O)CH₂CH₂S(O)p-, —C(OCH₃)₂CH₂CH₂S(O)p-, —C(NOH)CH₂CH₂S(O)p-, —C(NOCH₃)CH₂CH₂S(O)p-, —C(O)N(CH₃)SO₂—, p being 0, 1 or 2.

k) Q is a phenyl group wherein a group R₂ in the 4-position relative to the substituent —C(O)-Q is halomethyl, chlorine, bromine, nitro, methylthiomethyl, methylsulfinylmethyl, methylsulfonyl, methylsulfonyloxy, methylsulfonylamino or halomethylsulfonylamino and in the 2,3-positions relative to the substituent —C(Q)-Q is substituted by an annellated, bidentate ring system such as, preferably, —S(O)pCH₂CH₂—, —S(O)pCH(CH₃)CH₂—, —SO₂N(CH₃)C(O)—, —CH₂CH₂S(O)p-, —CH₂CH(CH₃)S(O)p-, —CH₂CH₂O—, —CH₂CH(CH₃)O—, —CH₂CH₂CH₂O—, —CH₂CH₂CH(CH₃)O— or —CH₂CH(CH₂OCH₃)O—, p being 0, 1 or 2;

l) Q is a mono- or di-substituted pyridyl or pyridyl-N-oxide group, especially a 3-pyridyl group substituted in the 2,4- or 2,6-positions;

m) Q is a mono- or di-substituted 3-pyridyl or 3-pyridyl-N-oxido group substituted in the 2-position by R₂ as defined above, preferably by C₁-C₃alkyl, fluoromethyl, difluoromethyl, trifluoromethyl, C₁-C₃alkoxy-C₁-C₄alkyl, C₁-C₃alkoxy-C₁-C₃alkoxy-C₁-C₃alkyl, C₁-C₃alkylthio-C₁-C₂alkyl, N—(C₁-C₃alkyl)-C₁-C₃alkylsulfonylaminomethyl or by N—(C₁-C₂alkoxy-C₁-C₂alkyl)-C₁-C₃alkylsulfonylaminomethyl, and in the 6-position by C₁-C₃alkyl, C₁-C₃haloalkyl, halogen, C₁-C₃alkoxy, C₁-C₃haloalkoxy, C₁-C₃alkylthio, C₁-C₃alkylsulfinyl, C₁-C₃alkylsulfonyl, C₁-C₃haloalkylthio, C₁-C₃haloalkylsulfinyl or by C₁-C₃haloalkylsulfonyl, preferably by difluoromethyl, difluorochloromethyl, trifluoromethyl or by pentafluoroethyl.

Preference is further given to compounds of formula I wherein either Q is a phenyl group substituted from one to four times by identical or different R₂ substituents, it being possible for the phenyl group also to include a further fused-on, saturated or unsaturated, 5- to 8-membered ring system which may be interrupted once, twice or three times by —O—, —NR₁₀—, —S(O)p- or by —C(X₂)— and substituted from one to three times by R₁₁; or Q is a pyridyl, pyridyl-N-oxido or pyrimidinyl group substituted from one to three times by identical or different R₂ substituents or is a 5-membered heteroaryl group substituted from one to three times by R₂; and A₁ is C(R₃R₄) or NR₂₁; A₂ is C(R₅R₆)ₘ, C(O), oxygen, NR₇ or S(O)q, and A₃ is C(R₈R₉) or NR₂₂; with the proviso that A₂ is other than NR₇ or S(O)q, when A₁ is NR₂₁ and/or A₃ is NR₂₂.

An especially preferred group of compounds of formula I comprises compounds of formula Ie

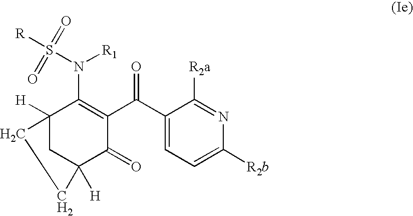

wherein

R is C₁-C₄alkyl, phenyl or benzyl, R₁ is C₁-C₄alkoxy-C₁-C₂alkyl or benzyl, R₂a is C₁-C₃alkyl, fluoromethyl, difluoromethyl, trifluoromethyl, C₁-C₃alkoxy-C₁-C₄alkyl or C₁-C₄alkoxy-C₁-C₄alkoxy-C₁-C₄alkyl and R₂b is difluoromethyl, difluorochloromethyl or trifluoromethyl.

The method according to the invention for the preparation of compounds of formula I

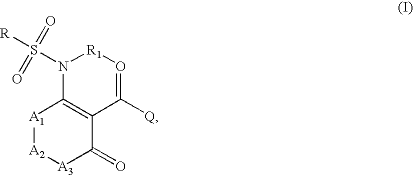

wherein A₁, A₂, A₃, R, R₁ and Q are as defined hereinbefore, comprises reacting a compound of formula II

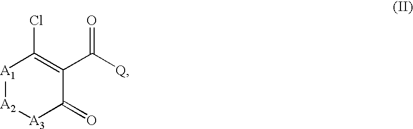

wherein A₁, A₂, A₃ and Q are as defined hereinbefore, with a sulfonamide of formula IlI

NHR₁SO₂R (III),

or with a salt of formula IlIa

M⁺⁻N R₁SO₂R (IIIa),

wherein R and R₁ are as defined hereinbefore and M⁺ is an alkaline earth metal cation or an alkali metal cation, preferably a lithium or sodium cation. In that method, the salt of formula IIIa either may be used as such or, preferably, may be formed in situ in the reaction mixture by addition of an appropriate base. The method according to the invention is illustrated in the following Scheme 1.

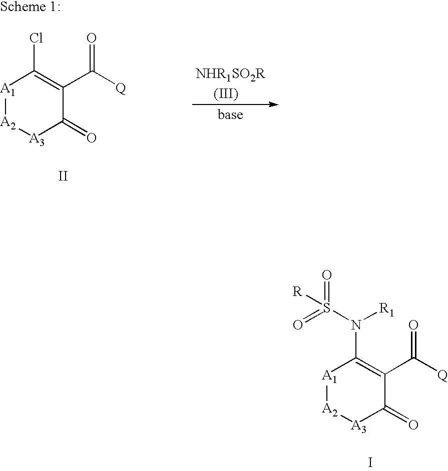

The compounds of formula II used as starting compounds are known or can be prepared using known methods, for example as described in WO 00/15615 and WO 00/39094, by converting a hydroxy compound of formula IV

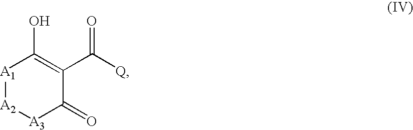

wherein A₁, A₂, A₃ and Q are as defined hereinbefore, using a chlorinating agent such as oxalyl chloride or thionyl chloride, into a chloro compound of formula II

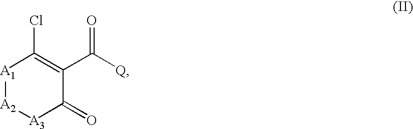

wherein A₁, A₂, A₃ and Q are as defined hereinbefore, as illustrated in general terms in Scheme 2.

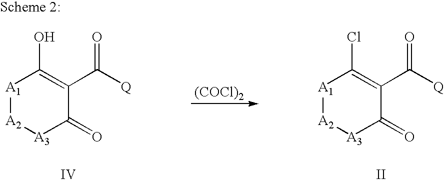

The compounds of formula III are likewise known from the literature or can be prepared using known procedures, by reacting a corresponding sulfonic acid chloride V

CISO₂R (V),

where appropriate in the presence of an auxiliary base, with a primary amine of formula VI

NH₂R₁ (VI).

The compounds of formula IV are likewise known and can be prepared, for example, in accordance with the processes described in WO 00/15615 and WO 00/39094.

In accordance with Reaction Scheme 2, the compounds of formula II are prepared using a chlorinating agent such as, for example, thionyl chloride, phosphorus pentachloride or phosphorus oxychloride or, preferably, oxalyl chloride. The reaction is carried out preferably in an inert, organic solvent such as, for example, in an aliphatic, halogenated aliphatic, aromatic or halogenated aromatic hydrocarbon, e.g. n-hexane, benzene, toluene, xylenes, dichloromethane, 1,2-dichloroethane and chlorobenzene, at reaction temperatures in the range from −20° C. to the reflux temperature of the reaction mixture, preferably at about from 40 to 100° C., and in the presence of a catalytic amount of N,N-dimethylformamide.

The end products of formula I can be isolated in conventional manner by concentrating or evaporating off the solvent and purified by recrystallising or triturating the solid residue in solvents in which they are not readily soluble, such as ethers, aromatic hydrocarbons or chlorinated hydrocarbons, by distillation or by means of column chromatography or by means of a HPLC technique using a suitable eluant.

Furthermore, the person skilled in the art will be familiar with the sequence in which certain reactions should advantageously be performed in order, where possible, to avoid subsidiary reactions.

Where synthesis is not directed at the isolation of pure isomers, the product may be in the form of a mixture of two or more isomers, for example chiral centres in the case of alkyl groups or cis/trans isomers in the case of alkenylene. All such isomers can be separated according to methods known per se.

Compounds of formula I wherein Q is pyridyl-N-oxide can be prepared by reacting a compound of formula I wherein Q is pyridyl with a suitable oxidising agent, for example a H₂O₂-urea adduct, in the presence of an acid anhydride, for example trifluoroacetic anhydride. That reaction may be performed at the stage of compounds of formula II or IV as well as in the case of compounds of formula I.

The reactions forming compounds of formula I are advantageously performed in aprotic, inert organic solvents. Such solvents are hydrocarbons, e.g. benzene, toluene, xylene and cyclohexane, chlorinated hydrocarbons, e.g. dichloromethane, trichloromethane, tetrachloromethane and chlorobenzene, ethers, e.g. diethyl ether, ethylene glycol dimethyl ether, diethylene glycol dimethyl ether, tetrahydrofuran and dioxane, nitriles, e.g. acetonitrile and propionitrile, amides, e.g. N,N-dimethylformamide, diethylformamide and N-methylpyrrolidinone. The reaction temperatures are preferably from −20° C. to +120° C. Where the reactions proceed slightly exothermically, they may generally be carried out at room temperature. In order to reduce the reaction time or to start the reaction, heating to the boiling point of the reaction mixture may, where appropriate, be carried out for a short time. The reaction times may also be reduced by addition of suitable bases as reaction catalysts. Especially suitable bases are tertiary amines, e.g. trimethylamine, triethylamine, quinuclidine, 1,4-diaza-bicyclo[2.2.2]octane, 1,5-diazabicyclo[4.3.0]non-5-ene and 1,5-diazabicyclo[5.4.0]undec-7-ene. Inorganic bases such as hydrides, e.g. sodium hydride and calcium hydride, hydroxides, e.g. dry sodium hydroxide and potassium hydroxide, carbonates, e.g. sodium carbonate and potassium carbonate, and hydrogen carbonates, e.g. sodium hydrogen carbonate and potassium hydrogen carbonate, may, however, also be used as bases.

For the use according to the invention of the compounds of formula I, or of compositions comprising them, there come into consideration all methods of application customary in agriculture, for example pre-emergence application, post-emergence application and seed dressing, and also various methods and techniques such as, for example, the controlled release of active ingredient. For that purpose a solution of the active ingredient is applied to mineral granule carriers or polymerised granules (urea/formaldehyde) and dried. If required, it is also possible to apply a coating (coated granules), which allows the active ingredient to be released in metered amounts over a specific period of time.

The compounds of formula I may be used as herbicides in their unmodified form, that is to say as obtained in the synthesis, but they are preferably formulated in customary manner together with the adjuvants conventionally employed in formulation technology, for example into emulsifiable concentrates, directly sprayable or dilutable solutions, dilute emulsions, wettable powders, soluble powders, dusts, granules or microcapsules. Such formulations are described, for example, on pages 9 to 13 of WO 97/34485. As with the nature of the compositions, the methods of application, such as spraying, atomising, dusting, wetting, scattering or pouring, are chosen in accordance with the intended objectives and the prevailing circumstances.

The formulations, that is to say the compositions, preparations or mixtures comprising the compound (active ingredient) of formula I or at least one compound of formula I and, usually, one or more solid or liquid formulation adjuvants, are prepared in known manner, e.g. by homogeneously mixing and/or grinding the active ingredients with the formulation adjuvants, for example solvents or solid carriers. Surface-active compounds (surfactants) may also be used in addition in the preparation of the formulations. Examples of solvents and solid carriers are given, for example, on page 6 of WO 97/34485.

Depending upon the nature of the compound of formula I to be formulated, suitable surface-active compounds are non-ionic, cationic and/or anionic surfactants and surfactant mixtures having good emulsifying, dispersing and wetting properties.

Examples of suitable anionic, non-ionic and cationic surfactants are listed, for example, on pages 7 and 8 of WO 97/34485.

In addition, the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna 1981, and M. and J. Ash, “Encyclopedia of Surfactants”, Vol. I-III, Chemical Publishing Co., New York, 1980-81, are also suitable for the preparation of the herbicidal compositions according to the invention.

The herbicidal formulations generally contain from 0.1 to 99% by weight, especially from 0.1 to 95% by weight, of herbicide, from 1 to 99.9% by weight, especially from 5 to 99.8% by weight, of a solid or liquid formulation adjuvant, and from 0 to 25% by weight, especially from 0.1 to 25% by weight, of a surfactant. Whereas commercial products will preferably be formulated as concentrates, the end user will normally employ dilute formulations. The compositions may also comprise further ingredients, such as stabilisers, for example vegetable oils or epoxidised vegetable oils (epoxidised coconut oil, rapeseed oil or soybean oil), anti-foams, for example silicone oil, preservatives, viscosity regulators, binders, tackifiers, and also fertilisers or other active ingredients.

The compounds of formula I are generally applied to the plant or the locus thereof at rates of application of from 0.001 to 4 kg/ha, especially from 0.005 to 2 kg/ha. The concentration required to achieve the desired effect can be determined by experiment. It is dependent on the nature of the action, the stage of development of the cultivated plant and of the weed and on the application (place, time, method) and may vary within wide limits as a function of those parameters.

The compounds of formula I are distinguished by herbicidal and growth-inhibiting properties, allowing them to be used in crops of useful plants, especially cereals, cotton, soybeans, sugar beet, sugar cane, plantation crops, rape, maize and rice, and also for non-selective weed control. The term “crops” is to be understood as including also crops that have been made tolerant to herbicides or classes of herbicides as a result of conventional methods of breeding or genetic engineering techniques. The weeds to be controlled may be either monocotyledonous or dicotyledonous weeds, such as, for example, Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, lpomoea, Chrysanthemum, Galium, Viola and Veronica.

The following Examples further illustrate but do not limit the invention.

### PREPARATION EXAMPLES

### Example P1

### Ethanesulfonic acid(2-methoxy-ethyl)-[3-(2-methyl-6-trifluoromethyl-pyridine-3-carbonyl)-4-oxo-bicyclo[3.2.1 ]oct-2-en-2-yl]-amide

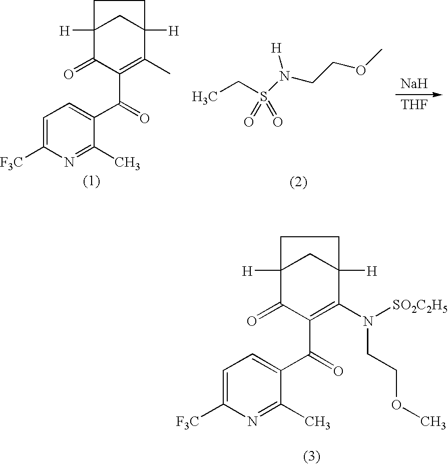

460 mg of compound 2 are dissolved in 30 ml of tetrahydrofuran. With stirring, 120 mg of sodium hydride (55% in oil) are added and stirred for 1 hour at room temperature. 859 mg of compound 1, dissolved in 5 ml of tetrahydrofuran, are then added, at a temperature of 0-5° C., to the reaction mixture. Stirring is then carried out for 12 hours at room temperature. The reaction mixture is then concentrated by evaporation in vacuo. The residue is taken up in ethyl acetate and washed three times with saturated sodium chloride solution. The organic phase is dried with sodium sulfate and concentrated in vacuo. The crude product is chromatographed at 0.6 bar on silica gel using hexane/ethyl acetate/tetrahydrofuran 5:5:1. In that manner, compound 3 (Table 1, Example 1.013) is obtained as a white-yellow solid; m.p. 58-59° C.

All other compounds of formula I can be prepared in accordance with the above procedures. In the following Table, “Me” denotes a methyl group.

TABLE 1
Compounds of formula I

| | |
|---|---|
| | (I) |
| 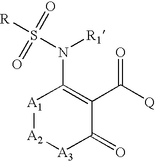 | |

| | | | | | | | Physical |
|---|---|---|---|---|---|---|---|
| Example no. | A₂ | A₁ | A₃ | Q | R | R₁ | data |
| 1.001 | C(O) | C(CH₃)₂ | C(CH₃)₂ | 2-CH₃-6-CF₃-pyrid-3-yl | CH₃ | CH₂CH₂OCH₃ | waxy |
| 1.002 | C(O) | C(CH₃)₂ | C(CH₃)₂ | 2-CH₃-6-CF₃-pyrid-3-yl | CH₂C(CH₃)═CH₂ | CH₂CH₂OCH₂ | |
| 1.003 | C(O) | C(CH₃)₂ | C(CH₃)₂ | 2-CH₃OCH₂-6-CF₃-pyrid-3-yl | CH₃ | CH₂CH₂OCH₃ | |
| 1.004 | C(O) | C(CH₃)₂ | C(CH₃)₂ | 2-CH₃OCH₂-6-CF₃-pyrid-3-yl | CH₂C(CH₃)═CH₂ | CH₂CH₂OCH₃ | |
| 1.005 | CH₂ | C(CH₃)₂ | C(CH₃)₂ | 2-CH₃-6-CF₃-pyrid-3-yl | CH₃ | CH₂CH₂OCH₃ | |
| 1.006 | C(O) | C(CH₃)₂ | C(CH₃)₂ | 2-CH₃-6-CF₃-pyrid-3-yl | CF₃ | CH₂CH₂OCH₃ | |
| 1.007 | C(O) | C(CH₃)₂ | C(CH₃)₂ | 2-CH₃-6-CF₃-pyrid-3-yl | CH₂CH₃ | CH₂CH₂OCH₃ | waxy |
| 1.008 | CH₂ | CH₂ | CH₂ | 2-CH₃-6-CF₃-pyrid-3-yl | CH₃ | CH₂CH₂OCH₃ | |
| 1.009 | CH₂ | CH₂ | C(CH₃)₂ | 2-CH₃-6-CF₃-pyrid-3-yl | CH₃ | CH₂CH₂OCH₃ | |
| 1.010 | CHCH₃ | CH₂ | CH₂ | 2-CH₃-6-CF₃-pyrid-3-yl | CH₃ | CH₂CH₂OCH₃ | |
| 1.011 | C(CH₃)₂ | CH₂ | CH₂ | 2-CH₃-6-CF₃-pyrid-3-yl | CH₃ | CH₂CH₂OCH₃ | |
| 1.012 | CH₂ | CH(CH₂CH₂)CH | | 2-CH₃-6-CF₃-pyrid-3-yl | CH₃ | CH₂CH₂OCH₃ | amorphous |
| 1.013 | CH₂ | CH(CH₂CH₂)CH | | 2-CH₃-6-CF₃-pyrid-3-yl | CH₂CH₃ | CH₂CH₂OCH₃ | 58-59° C. |
| (P1) | | | | | | | |
| 1.014 | CH₂ | CH(CH₂CH₂)CH | | 2-CH₃-6-CF₃-pyrid-3-yl | n-propyl | CH₂CH₂OCH₃ | |
| 1.015 | CH₂ | CH(CH₂CH₂)CH | | 2-CH₃-6-CF₃-pyrid-3-yl | n-butyl | CH₂CH₂OCH₃ | |
| 1.016 | CH₂ | CH(CH₂CH₂)CH | | 2-CH₃-6-CF₃-pyrid-3-yl | CH₂C(CH₃)═CH₂ | CH₂CH₂OCH₃ | |
| 1.017 | CH₂ | CH(CH₂CH₂)CH | | 2-CH₃-6-CF₃-pyrid-3-yl | CF₃ | CH₂CH₂OCH₃ | |
| 1.018 | CH₂ | CH(CH₂CH₂)CH | | 2-NO₂-4-SO₂CH₃-phenyl | CF₃ | CH₂CH₂OCH₃ | |
| 1.019 | CH₂ | CH(CH₂CH₂)CH | | 2-CH₂-3-OCH₃-4-SO₂CH₃-phenyl | CH₃ | CH₂CH₂OCH₃ | |
| 1.020 | CH₂ | CH(CH₂CH₂)CH | | 2-Cl-3-OCH₃-4-SO₂CH₃-phenyl | CH₃ | CH₂CH₂OCH₃ | |
| 1.021 | CHCH₃ | CH₂ | CH₂ | 2-Cl-3-OCH₃-4-SO₂CH₃-phenyl | CH₃ | CH₂CH₂OCH₃ | |
| 1.022 | CH₂ | CH₂ | CH₂ | 2-NO₂-4-SO₂CH₃-phenyl | CH₃ | CH₂CH₂OCH₃ | |
| 1.023 | CH(CH₃) | CH₂ | CH₂ | 2-NO₂-4-SO₂CH₃-phenyl | CH₃ | CH₂CH₂OCH₃ | |
| 1.024 | C(O) | C(CH₃)₂ | C(CH₃)₂ | 2-CH₃-4-CN-phenyl | CH₃ | CH₂CH₂OCH₃ | |
| 1.025 | C(O) | C(CH₃)₂ | C(CH₃)₂ | 2-CH₃-6-CF₃-pyrid-3-yl | 3-COOMe-pyrid-2-yl | CH₂CH₂OCH₃ | |
| 1.026 | C(O) | C(CH₃)₂ | C(CH₃)₂ | 2-CH₃-6-CF₃-pyrid-3-yl | 2-F-pyrid-3-yl | | |
| 1.027 | CH₂ | —CH(CH₂CH₂)CH— | | 2-CH₃-6-CF₃-pyrid-3-yl | phenyl | CH₂CH₂OCH₃ | resin |
| 1.028 | CH₂ | —CH(CH₂CH₂)CH— | | 2-CH₃-6-CF₃-pyrid-3-yl | vinyl | CH₂CH₂OCH₃ | |
| 1.029 | CH₂ | —CH(CH₂CH₂)CH— | | 2-CH₃-6-CF₃-pyrid-3-yl | CH₂Cl | CH₂CH₂OCH₃ | |
| 1.030 | CH₂ | —CH(CH₂CH₂)CH— | | 2-CH₃-6-CF₃-pyrid-3-yl | 2-Cl-pyrid-3-yl | CH₂CH₂OCH₃ | |
| 1.031 | CH₂ | —CH(CH₂CH₂)CH— | | 2-CH₃-6-CHF₂-pyrid-3-yl | phenyl | CH₂CH₂OCH₃ | |
| 1.032 | CH₂ | —CH(CH₂CH₂)CH— | | 2-CH₃-6-CF₃-pyrid-3-yl | p-tolyl | CH₂CH₂OCH₃ | |
| 1.033 | CH₂ | —CH(CH₂CH₂)CH— | | 2-CH₃-6-CF₃-pyrid-3-yl | 4-OMe-phenyl | CH₂CH₂OCH₃ | |
| 1.034 | CH₂ | —CH(CH₂CH₂)CH— | | 2-CH₃-6-CF₃-pyrid-3-yl | 4-Cl-phenyl | CH₂CH₂OCH₃ | |
| 1.035 | CH₂ | —CH(CH₂CH₂)CH— | | 2-CH₃-6-CF₃-pyrid-3-yl | 3-CF₃-phenyl | CH₂CH₂OCH₃ | |
| 1.036 | CH₂ | —CH(CH₂CH₂)CH— | | 2-CH₃-6-CF₃-pyrid-3-yl | 2-Cl-phenyl | CH₂CH₂OCH₃ | |
| 1.037 | CH₂ | —CH(CH₂CH₂)CH— | | 2-CH₃-6-CF₃-pyrid-3-yl | 2-ClCH₂CH₂O-phenyl | CH₂CH₂OCH₃ | |
| 1.038 | CH₂ | —CH(CH₂CH₂)CH— | | 2-CH₃-6-CF₃-pyrid-3-yl | 2-COOMe-phenyl | CH₂CH₂OCH₃ | |
| 1.039 | CH₂ | —CH(CH₂CH₂)CH— | | 2-CH₃-6-CF₃-pyrid-3-yl | 2-CONMe₂-phenyl | CH₂CH₂OCH₃ | |
| 1.040 | CH₂ | —CH(CH₂CH₂)CH— | | 2-CH₃-6-CF₃-pyrid-3-yl | 2-OCHF₂-phenyl | CH₂CH₂OCH₃ | |
| 1.041 | CH₂ | —CH(CH₂CH₂)CH— | | 2-CH₃-6-CF₃-pyrid-3-yl | 3-OCHF₂-pyrid-2-yl | CH₂CH₂OCH₃ | |
| 1.042 | CH₂ | —CH(CH₂CH₂)CH— | | 2-CH₃-6-CF₃-pyrid-3-yl | 3-F-pyrid-2-yl | CH₂CH₂OCH₃ | |
| 1.043 | CH₂ | —CH(CH₂CH₂)CH— | | 2-CH₃-6-CF₃-pyrid-3-yl | 2-COOMe-thien-3-yl | CH₂CH₂OCH₃ | |
| 1.044 | CH₂ | —CH(CH₂CH₂)CH— | | 2-CH₃-6-CF₃-pyrid-3-yl | 5-Cl-thien-2-yl | CH₂CH₂OCH₃ | |
| 1.045 | CH₂ | —CH(CH₂CH₂)CH— | | 2-CH₃-6-CF₃-pyrid-3-yl | 3-CONMe₂-pyrid-2-yl | CH₂CH₂OCH₃ | |
| 1.046 | CH₂ | —CH(CH₂CH₂)CH— | | 2-CH₃-6-CF₃-pyrid-3-yl | N(CH₃)₂ | CH₂CH₂OCH₃ | |
| 1.047 | CH₂ | —CH(CH₂CH₂)CH— | | 2-CH₃-6-CF₃-pyrid-3-yl | C(CH₃)₂ | CH₂CH₂OCH₃ | |
| 1.048 | CH₂ | —CH(CH₂CH₂)CH— | | 2-CH₃-6-CF₃-pyrid-3-yl | CH₂CH₂CH₂CH₃ | CH₂CH₂OCH₃ | |
| 1.049 | CH₂ | —CH(CH₂CH₂)CH— | | 2-CH₃-6-CF₃-pyrid-3-yl | n-octyl | CH₂CH₂OCH₃ | |
| 1.050 | CH₂ | —CH(CH₂CH₂)CH— | | 2-CH₃-6-CF₃-pyrid-3-yl | CHCl₂ | CH₂CH₂OCH₃ | |
| 1.051 | CH₂ | —CH(CH₂CH₂)CH— | | 2-CH₃OCH₂CH₂OCH₂-6-CF₃-pyrid-3-yl | CH₃ | CH₂CH₂OCH₃ | |
| 1.052 | CH₂ | —CH(CH₂CH₂)CH— | | 2-CH₃OCH₂CH₂OCH₂-6-CF₃-pyrid-3-yl | CH₂CH₃ | CH₂CH₂OCH₃ | |
| 1.053 | C(O) | C(CH₃)₂ | C(CH₃)₂ | 2-CH₃-6-CF₃-pyrid-3-yl | CH₃ | benzyl | |
| 1.054 | C(O) | C(CH₃)₂ | C(CH₃)₂ | 2-CH₃-6-CF₃-pyrid-3-yl | CH₂C(CH₃)═CH₂ | benzyl | |
| 1.055 | C(O) | C(CH₃)₂ | C(CH₃)₂ | 2-CH₃OCH₂-6-CF₃-pyrid-3-yl | CH₃ | benzyl | |
| 1.056 | C(O) | C(CH₃)₂ | C(CH₃)₂ | 2-CH₃OCH₂-6-CF₃-pyrid-3-yl | CH₂C(CH₃)═CH₂ | benzyl | |
| 1.057 | CH₂ | C(CH₃)₂ | C(CH₃)₂ | 2-CH₃-6-CF₃-pyrid-3-yl | CH₃ | benzyl | |
| 1.058 | C(O) | C(CH₃)₂ | C(CH₃)₂ | 2-CH₃-6-CF₃-pyrid-3-yl | CF₃ | benzyl | |
| 1.059 | C(O) | C(CH₃)₂ | C(CH₃)₂ | 2-CH₃-6-CF₃-pyrid-3-yl | CH₂CH₃ | benzyl | |
| 1.060 | CH₂ | CH₂ | CH₂ | 2-CH₃-6-CF₃-pyrid-3-yl | CH₃ | benzyl | |
| 1.061 | CH₂ | CH₂ | CHCH₃ | 2-CH₃-6-CF₃-pyrid-3-yl | CH₃ | benzyl | |
| 1.062 | CHCH₃ | CH₂ | CH₂ | 2-CH₃-6-CF₃-pyrid-3-yl | CH₃ | benzyl | |
| 1.063 | C(CH₃)₂ | CH₂ | CH₂ | 2-CH₃-6-CF₃-pyrid-3-yl | CH₃ | benzyl | |
| 1.064 | CH₂ | CH(CH₂CH₂)CH | | 2-CH₃-6-CF₃-pyrid-3-yl | CH₃ | benzyl | |
| 1.065 | CH₂ | CH(CH₂CH₂)CH | | 2-CH₃-6-CF₃-pyrid-3-yl | CH₂CH₃ | benzyl | 109-110° C. |
| 1.066 | CH₂ | CH(CH₂CH₂)CH | | 2-CH₃-6-CF₃-pyrid-3-yl | n-propyl | benzyl | |
| 1.067 | CH₂ | CH(CH₂CH₂)CH | | 2-CH₃-6-CF₃-pyrid-3-yl | isopropyl | benzyl | 171-185° C. |
| 1.068 | CH₂ | CH(CH₂CH₂)CH | | 2-CH₃-6-CF₃-pyrid-3-yl | CH₂C(CH₃)═CH₂ | benzyl | |
| 1.069 | CH₂ | CH(CH₂CH₂)CH | | 2-CH₃-6-CF₃-pyrid-3-yl | CF₃ | benzyl | |
| 1.070 | CH₂ | CH(CH₂CH₂)CH | | 2-NO₂-4-SO₂CH₃-phenyl | CF₃ | benzyl | |
| 1.071 | CH₂ | CH(CH₂CH₂)CH | | 2-CH₂-3-OCH₃-4-SO₂CH₃-phenyl | CH₃ | benzyl | |
| 1.072 | CH₂ | CH(CH₂CH₂)CH | | 2-Cl-3-OCH₃-4-SO₂CH₃-phenyl | CH₃ | benzyl | |
| 1.073 | CHCH₃ | CH₂ | CH₂ | 2-Cl-3-OCH₃-4-SO₂CH₃-phenyl | CH₃ | benzyl | |
| 1.074 | CH₂ | CH₂ | CH₂ | 2-NO₂-4-SO₂CH₃-phenyl | CH₃ | benzyl | |
| 1.075 | CH(CH₃) | CH₂ | CH₂ | 2-NO₂-4-SO₂CH₃-phenyl | CH₃ | benzyl | |
| 1.076 | C(O) | C(CH₃)₂ | C(CH₃)₂ | 2-NO₂-4-CN-phenyl | CH₃ | benzyl | |
| 1.077 | C(O) | C(CH₃)₂ | C(CH₃)₂ | 2-CH₃-6-CF₃-pyrid-3-yl | 3-COOMe-pyrid-2-yl | benzyl | |
| 1.078 | C(O) | C(CH₃)₂ | C(CH₃)₂ | 2-CH₃-6-CF₃-pyrid-3-yl | 2-F-pyrid-3-yl | benzyl | |
| 1.079 | CH₂ | —CH(CH₂CH₂)CH— | | 2-CH₃-6-CF₃-pyrid-3-yl | phenyl | benzyl | 115-116° C. |
| 1.080 | CH₂ | —CH(CH₂CH₂)CH— | | 2-CH₃-6-CF₃-pyrid-3-yl | vinyl | benzyl | |
| 1.081 | CH₂ | —CH(CH₂CH₂)CH— | | 2-CH₃-6-CF₃-pyrid-3-yl | CH₂Cl | benzyl | |
| 1.082 | CH₂ | —CH(CH₂CH₂)CH— | | 2-CH₃-6-CF₃-pyrid-3-yl | 2-Cl-pyrid-3-yl | benzyl | |
| 1.083 | CH₂ | —CH(CH₂CH₂)CH— | | 2-CH₃-6-CHF₂-pyrid-3-yl | phenyl | benzyl | |
| 1.084 | CH₂ | —CH(CH₂CH₂)CH— | | 2-CH₃-6-CF₃-pyrid-3-yl | p-tolyl | benzyl | |
| 1.085 | CH₂ | —CH(CH₂CH₂)CH— | | 2-CH₃-6-CF₃-pyrid-3-yl | 4-OMe-phenyl | benzyl | |
| 1.086 | CH₂ | —CH(CH₂CH₂)CH— | | 2-CH₃-6-CF₃-pyrid-3-yl | 4-Cl-phenyl | benzyl | |
| 1.087 | CH₂ | —CH(CH₂CH₂)CH— | | 2-CH₃-6-CF₃-pyrid-3-yl | 3-CF₃-phenyl | benzyl | |
| 1.088 | CH₂ | —CH(CH₂CH₂)CH— | | 2-CH₃-6-CF₃-pyrid-3-yl | 2-Cl-phenyl | benzyl | |
| 1.089 | CH₂ | —CH(CH₂CH₂)CH— | | 2-CH₃-6-CF₃-pyrid-3-yl | 2-ClCH₂CH₂O-phenyl | benzyl | |
| 1.090 | CH₂ | —CH(CH₂CH₂)CH— | | 2-CH₃-6-CF₃-pyrid-3-yl | 2-COOMe-phenyl | benzyl | |
| 1.091 | CH₂ | —CH(CH₂CH₂)CH— | | 2-CH₃-6-CF₃-pyrid-3-yl | 2-CONMe₂-phenyl | benzyl | |
| 1.092 | CH₂ | —CH(CH₂CH₂)CH— | | 2-CH₃-6-CF₃-pyrid-3-yl | 2-OCHF₂-phenyl | benzyl | |
| 1.093 | CH₂ | —CH(CH₂CH₂)CH— | | 2-CH₃-6-CF₃-pyrid-3-yl | 3-OCHF₂-pyrid-2-yl | benzyl | |
| 1.094 | CH₂ | —CH(CH₂CH₂)CH— | | 2-CH₃-6-CF₃-pyrid-3-yl | 3-F-pyrid-2-yl | benzyl | |
| 1.095 | CH₂ | —CH(CH₂CH₂)CH— | | 2-CH₃-6-CF₃-pyrid-3-yl | 2-COOMe-thien-3-yl | benzyl | |
| 1.096 | CH₂ | —CH(CH₂CH₂)CH— | | 2-CH₃-6-CF₃-pyrid-3-yl | 5-Cl-thien-2-yl | benzyl | |
| 1.097 | CH₂ | —CH(CH₂CH₂)CH— | | 2-CH₃-6-CF₃-pyrid-3-yl | 3-CONMe₂-pyrid-2-yl | benzyl | |
| 1.098 | CH₂ | —CH(CH₂CH₂)CH— | | 2-CH₃-6-CF₃-pyrid-3-yl | N(CH₃)₂ | benzyl | |
| 1.099 | CH₂ | —CH(CH₂CH₂)CH— | | 2-CH₃-6-CF₃-pyrid-3-yl | C(CH₃)₂ | benzyl | |
| 1.100 | CH₂ | —CH(CH₂CH₂)CH— | | 2-CH₃-6-CF₃-pyrid-3-yl | CH₂CH₂CH₂CH₃ | benzyl | |
| 1.101 | C(O) | C(CH₃)₂ | C(CH₃)₂ | 2-CH₃-6-CF₃-pyrid-3-yl | n-octyl | benzyl | |
| 1.102 | C(O) | C(CH₃)₂ | C(CH₃)₂ | 2-CH₃-6-CF₃-pyrid-3-yl | CHCl₂ | benzyl | |

| | | | | | |
|---|---|---|---|---|---|
| 1.103 | CH₂ | —CH(CH₂CH₂)CH— | 2-CH₃OCH₂CH₂OCH₂-6-CF₃-pyrid-3-yl | CH₃ | benzyl |
| 1.104 | CH₂ | —CH(CH₂CH₂)CH— | 2-CH₂OCH₂CH₂OCH₃-6-CF₃-pyrid-3-yl | CH₂CH₃ | benzyl |
| 1.105 | CH₂ | —CH(CH₂CH₂)CH— | 2-CH₃-6-CHF₂-pyrid-3-yl | CH₃ | CH₂OCH₃ |
| 1.106 | CH₂ | —CH(CH₂CH₂)CH— | 2-CH₃-6-CF₃-pyrid-3-yl | CH₃ | CH₂OCH₃ |
| 1.107 | CH₂ | —CH(CH₂CH₂)CH— | 2-CH₃-6-CF₃-pyrid-3-yl | CH₃ | CH₂OCH₂CH₃ |
| 1.108 | CH₂ | —CH(CH₂CH₂)CH— | 2-CH₃-6-CF₃-pyrid-3-yl | CH₂CH₃ | CH₂OCH₃ |
| 1.109 | CH₂ | —CH(CH₂CH₂)CH— | 2-CH₃-6-CF₃-pyrid-3-yl | CH₂CH₃ | CH₂OCH₂CH₃ |
| 1.110 | CH₂ | —CH(CH₂CH₂)CH— | 2-CH₃-6-CClF₂-pyrid-3-yl | CH₃ | CH₂OCH₃ |
| 1.111 | CH₂ | —CH(CH₂CH₂)CH— | 2-CH₃-6-CHF₂-pyrid-3-yl | CH₃ | CH₂OCH₃ |
| 1.112 | CH₂ | —CH(CH₂CH₂)CH— | 2-CH₃-6-CF₃-pyrid-3-yl | CH₃ | CH₂COOCH₃ |
| 1.113 | CH₂ | —CH(CH₂CH₂)CH— | 2-CH₃-6-CF₃-pyrid-3-yl | CH₃ | CH₂CH═CH₃ |
| 1.114 | CH₂ | —CH(CH₂CH₂)CH— | 2-CH₃-6-CF₃-pyrid-3-yl | CH₃ | CH₂CH═CCl₂ |
| 1.115 | CH₂ | —CH(CH₂CH₂)CH— | 2-CH₃-6-CF₃-pyrid-3-yl | CH₂CH₃ | CH₂CH═CH₃ |
| 1.116 | CH₂ | —CH(CH₂CH₂)CH— | 2-CH₃-6-CF₃-pyrid-3-yl | CH₂CH₃ | CH₂CH═CCl₂ |
| 1.117 | CH₂ | —CH(CH₂CH₂)CH— | 2-CH₃-6-CF₃-pyrid-3-yl | CH₃ | CH₂CCH |
| 1.118 | CH₂ | —CH(CH₂CH₂)CH— | 2-CH₃-6-CF₃-pyrid-3-yl | CH₂CH₃ | CH₂CCH |
| 1.119 | CH₂ | —CH(CH₂CH₂)CH— | 2-CH₃-6-CF₃-pyrid-3-yl | CH₃ | phenyl |
| 1.120 | CH₂ | —CH(CH₂CH₂)CH— | 2-CH₃-6-CF₃-pyrid-3-yl | —CH₂CH₂CH₂— | |
| 1.121 | CH₂ | —CH(CH₂CH₂)CH— | 2-CH₃O(CH₂)₃-6-CF₃-pyrid-3-yl | CH₃ | CH₂CH₂OCH₃ |
| 1.122 | CH₂ | —CH(CH₂CH₂)CH— | 2-CH₃O(CH₂)₃-6-CF₃-pyrid-3-yl | CH₃CH₂ | CH₂CH₂OCH₃ |
| 1.123 | CH₂ | —CH(CH₂CH₂)CH— | 2-CH₃O(CH₂)₂-6-CF₃-pyrid-3-yl | CH₃ | CH₂CH₂OCH₃ |
| 1.124 | CH₂ | —CH(CH₂CH₂)CH— | 2-CH₃O(CH₂)2-6-CF₃-pyrid-3-yl | CH₃ | CH₂CH₂OCH₃ |
| 1.125 | CH₂ | —CH(CH₂CH₂)CH— | 2-CH₃-6-CF₂H-pyrid-3-yl | CH₃ | CH₂CH₂OCH₃ |
| 1.126 | CH₂ | —CH(CH₂CH₂)CH— | 2-CH₃-6-CF₂H-pyrid-3-yl | CH₃CH₂ | CH₂CH₂OCH₃ |
| 1.127 | 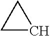 | CH₂ | 2-CH₃-6-CF₂H-pyrid-3-yl | CH₃ | CH₂CH₂OCH₃ |
| 1.128 | 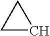 | CH₂ | 2-CH₃-6-CF₂H-pyrid-3-yl | CH₃CH₂ | CH₂CH₂OCH₃ |

### BIOLOGICAL EXAMPLES

### Example B1

### Herbicidal Action Prior to Emergence of the Plants (Pre-Emergence Action)

Monocotyledonous and dicotyledonous test plants are sown in standard soil in plastic pots. Immediately after sowing, the test compounds, in the form of an aqueous suspension (prepared from a 25% wettable powder (Example F3, b) according to WO 97/34485) or in the form of an emulsion (prepared from a 25% emulsifiable concentrate (Example F1, c)), are applied by spraying, in an amount corresponding to 250 g of active ingredient per ha (500 litres of water per ha). The test plants are then grown in a greenhouse under optimum conditions. After a test duration of 3 weeks, the test is evaluated in accordance with a scale of nine ratings (1=total damage, 9=no action). Ratings of from 1 to 4 (especially from 1 to 3) indicate good to very good herbicidal action.

TABLE B1
Pre-emergence action of the compounds of formula I:

| Ex. no | SETARI | PANICU | DIGITA | ECHINO | ABUTIL | AMARAN | CHENOP | STELLA |
|---|---|---|---|---|---|---|---|---|
| 1.001 | 2 | 1 | 1 | 1 | 1 | 1 | 1 | 4 |
| 1.007 | 1 | 1 | 1 | 1 | 1 | 1 | 1 | 1 |
| 1.012 | 1 | 1 | 1 | 1 | 1 | 1 | — | 4 |
| 1.013 | 1 | 1 | 1 | 1 | 1 | 1 | 1 | 1 |
| 1.027 | 2 | 2 | 2 | 3 | 3 | 2 | 9 | 9 |
| 1.065 | 1 | 1 | 1 | 1 | 1 | 2 | 2 | 1 |
| 1.067 | 1 | 1 | 1 | 2 | 2 | 2 | 1 | 1 |
| 1.079 | 6 | 1 | 3 | 2 | 4 | 3 | 2 | 2 |

The same results are obtained when the compounds of formula I are formulated in accordance with Examples F2 and F4 to F8 according to WO 97/34485.

### Example B2

### Post-Emergence Herbicidal Action

Monocotyledonous and dicotyledonous test plants are grown in standard soil in plastic pots in a greenhouse and, at the 4- to 6-leaf stage, are sprayed with an aqueous suspension of the test compounds of formula I, prepared from a 25% wettable powder (Example F3, b) according to WO 97/34485 or with an emulsion of the test compounds of formula I, prepared from a 25% emulsifiable concentrate (Example F1, c) according to WO 97/34485, in an amount corresponding to 250 g of active ingredient per ha (500 litres of water per ha). The test plants are then grown on in the greenhouse under optimum conditions. After a test duration of about 18 days, the test is evaluated in accordance with a scale of nine ratings (1=total damage, 9=no action). Ratings of from 1 to 4 (especially from 1 to 3) indicate good to very good herbicidal action. In this test, the compounds of formula I exhibit strong herbicidal action.

TABLE B2
Post-emergence action of the compounds of formula I:

| Ex. no. | SETARI | PANICU | DIGITA | ECHINO | EUPHOR | ABUTIL | AMARAN | CHENOP |
|---|---|---|---|---|---|---|---|---|
| 1.001 | 2 | 1 | 1 | 2 | 2 | 1 | 2 | 1 |
| 1.007 | 2 | 1 | 1 | 2 | 2 | 1 | 2 | 1 |
| 1.012 | 2 | 2 | 2 | 2 | 2 | 2 | 2 | 1 |
| 1.013 | 2 | 1 | 2 | 2 | 2 | 2 | 1 | 1 |
| 1.065 | 5 | 2 | 2 | 3 | 3 | 2 | 2 | 1 |

What is claimed is:

1. A compound of formula I 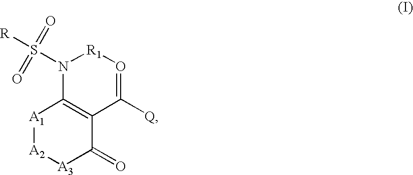
wherein
Q is a phenyl group substituted from one to four times by identical or different R₂ substituents, it also being possible for the phenyl group to contain a further fused-on, monocyclic or bicyclic, saturated, partially saturated or unsaturated, 5- to 8-membered ring system which may be interrupted once, twice or three times by —O—, —NR₁₀—, —S(O)p- or by —C(X₂)— and may be substituted from one to three times by identical or different R₁₁ substituents;
or Q is a pyridyl, pyridyl-N-oxido or pyrimidinyl group substituted from one to three times by identical or different R₂ substituents or is a 5-membered heteroaryl group substituted from one to three times by identical or different R₂ substituents;
A₁ is C(R₃R₄) or NR₂₁;
A₂ is C(R₅R₆)ₘ, C(O), oxygen, NR₇ or S(O)q;
A₃ is C(R₈R₉) or NR₂₂;
with the proviso that A₂ is other than S(O)q when A₁ is NR₂₁ and/or A₃ is NR₂₂;
m is 1 or 2;
n, p, q, r, s, t, u, v and w are each independently of the others 0, 1 or 2;
R is C₁-C₁₂alkyl, C₁-C₁₂haloalkyl, C₂-C₁₂alkenyl, C₂-C₁₂haloalkenyl, C₁-C₂alkoxycarbonyl- or phenyl-substituted vinyl; C₂-C₁₂alkynyl, C₂-C₁₂haloalkynyl, C₃-C₁₂allenyl, C₃-C₆cycloalkyl, C₃-C₆cycloalkyl-C₁-C₃alkyl, C₁-C₄alkoxy-C₁-C₁₂alkyl, C₁-C₄alkylthio-C₁-C₁₂alkyl, C₁-C₄alkylsulfinyl-C₁-C₁₂alkyl, C₁-C₄alkylsulfonyl-C₁-C₁₂alkyl, cyano-C₁-C₁₂alkyl, hydroxy-C₁-C₁₂alkyl, C₁-C₆alkylcarbonyloxy-C₁-C₁₂alkyl, C₁-C₄alkoxycarbonyl-C₁-C₁₂alkyl, C₁-C₄alkoxycarbonyloxy-C₁-C₁₂alkyl, rhodano-C₁-C₁₂alkyl, benzoyloxy-C₁-C₁₂alkyl, C₁-C₄alkylamino-C₁-C₁₂alkyl, di(C₁-C₄alkyl)amino-C₁-C₁₂alkyl, C₁-C₁₂alkylthiocarbonyl-C₁-C₁₂alkyl, formyl-C₁-C₁₂alkyl, phenyl-C₁-C₃alkylene which may be interrupted by oxygen or by —S(O)s-, or is NR₁₃R₁₄ or phenyl, it being possible for phenyl and the phenyl-containing radicals to be substituted in each case from one to five times by C₁-C₄alkyl, C₂-C₄alkenyl, C₁-C₄haloalkyl, C₁-C₄alkoxy, C₁-C₄haloalkoxy, halogen, S(O)ᵣR₁₅, S(O)₂NR₁₆R₁₇, cyano, C₁-C₄alkoxycarbonyl, C₁-C₄alkylcarbonyl, cyclopropylcarbonyl or by nitro;
or R is a five- or six-membered monocyclic or annellated bicyclic ring system, which may be aromatic, partially saturated or fully saturated and may contain from 1 to 3 hetero atoms selected from nitrogen, oxygen and sulfur, the ring system being bonded to the sulfur atom of the group —SO₂N(R₁)— either directly by a carbon atom or a nitrogen atom or by way of a C₁-C₃alkylene chain which may be interrupted by oxygen or by —S(O)s-, each ring system containing no more than 2 oxygen atoms and no more than two sulfur atoms, and it being possible for each ring system itself to be substituted from one to three times by C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, C₁-C₆haloalkoxy, C₃-C₆alkenyloxy, C₃-C₆alkynyloxy, mercapto, C₁-C₆alkylthio, C₁-C₆haloalkylthio, C₂-C₆alkenylthio, C₂-C₆haloalkenylthio, C₂-C₆alkynylthio, C₁-C₃alkoxy-C₁-C₃alkylthio, C₁-C₄alkylcarbonyl-C₁-C₃alkylthio, C₁-C₄alkoxycarbonyl-C₁-C₃alkylthio, cyano-C₁-C₃alkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₂alkyl)aminosulfonyl, R₂₀—C₁-C₃alkylene (wherein the alkylene chain may be interrupted by oxygen or by —S(O)t-), di(C₁-C₄alkyl)amino, halogen, cyano, nitro or by phenyl, it being possible for phenyl itself to be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring do not contain halogen;
R₁is C₁-C₆alkyl, C₂-C₆alkenyl, C₂-C₆alkynyl, C₁-C₆haloalkyl, C₂-C₆haloalkenyl, C₂-C₆haloalkynyl, C₁-C₄alkoxy-C₁-C₂alkyl, C₁-C₄alkylcarbonyloxy-C₁-C₆alkyl, C₁-C₄alkoxycarbonyl-C₁-C₄alkyl, phenyl or benzyl, it being possible for the phenyl-containing groups to be substituted one or more times by halogen, C₁-C₄alkyl, C₁-C₂haloalkyl, C₁-C₂alkoxy, C₁-C₂haloalkoxy or by nitro;
or R₁ forms, together with R, a 4- to 7-membered ring which may be substituted by C₁-C₃-alkyl or may be interrupted by —O—, —NR₂₃-, —S(O)u- or by —C(X₁)—;
with the proviso that R₁ is other than C₁-C₆alkyl when 0 is a phenyl, pyridyl or pyridyl-N-oxido group;
each R₂ independently is hydrogen, halogen, C₁-C₆alkyl, C₁-C₆haloalkyl, C₂-C₆alkenyl, C₂-C₆haloalkenyl, C₂-C₆alkynyl, C₂-C₆haloalkynyl, C₃-C₆cycloalkyl, C₁-C₆alkoxy, C₁-C₆haloalkoxy, C₃-C₆alkenyloxy, C₃-C₆alkynyloxy, C₁-C₆alkylthio, C₁-C₆alkylsulfinyl, C₁-C₆alkylsulfonyl, C₁-C₆haloalkylthio, C₁-C₆haloalkylsulfinyl, C₁-C₆haloalkylsulfonyl, C₁-C₆alkoxycarbonyl, C₁-C₆alkylcarbonyl, C₁-C₆alkylamino, di(C₁-C₆alkyl)amino, C₁-C₆alkylaminosulfonyl, di(C₁-C₆alkyl)aminosulfonyl, —N(R₁₈)—SO₂—R₁₉, nitro, cyano, hydroxy, amino, formyl, hydroxy-C₁-C₆alkyl, C₁-C₆alkoxy-C₁-C₆alkyl, C₁-C₆haloalkoxy-C₁-C₆alkyl, C₁-C₆alkylcarbonyloxy-C₁-C₄alkyl, C₁-C₆alkoxycarbonyloxy-C₁-C₆alkyl, C₁-C₆alkylthio-C₁-C₆alkyl, C₁-C₆alkylsulfinyl-C₁-C₆alkyl, C₁-C₆alkylsulfonyl-C₁-C₆alkyl, rhodano-C₁-C₆alkyl, cyano-C₁-C₆alkyl, C₃-C₆alkenyloxy-C₁-C₃alkyl, C₃-C₆alkynyloxy-C₁-C₃alkyl, C₁-C₆alkoxy-C₁-C₆alkoxy-C₁-C₃alkyl, C₁-C₆haloalkoxy-C₁-C₆alkoxy-C₁-C₆alkyl, C₁-C₄alkoxy-C₁-C₄alkoxy-C₁-C₄alkoxy-C₁-C₃alkyl, C₁-C₄alkoxy-C₁-C₄alkoxy-C₁-C₄alkoxy-C₁-C₄alkoxy-C₁-C₃alkyl, C₁-C₈alkylcarbonyloxy-C₁-C₄alkoxy-C₁-C₄alkyl, C₁-C₆alkoxy-C₁-C₆alkoxy, C₁-C₆alkoxycarbonyloxy-C₁-C₆alkoxy, cyano-C₁-C₆alkoxy, cyano-C₁-C₆alkenyloxy, C₁-C₆alkoxycarbonyl-C₁-C₆alkoxy-C₁-C₃alkyl, C₁-C₆alkoxycarbonyl-C₁-C₆alkoxy, C₁-C₆alkylthio-C₁-C₆alkoxy, C₁-C₆alkylthio-C₁-C₆alkoxy-C₁-C₃alkyl, C₁-C₆alkoxycarbonyl-C₁-C₆alkylthio, C₁-C₆alkoxycarbonyl-C₁-C₆alkylthio-C₁-C₃alkyl, C₁-C₆alkoxycarbonyl-C₁-C₆alkylsulfinyl, C₁-C₆alkoxycarbonyl-C₁-C₆alkylsulfinyl-C₁-C₃alkyl, C₁-C₆alkoxycarbonyl-C₁-C₆alkylsulfonyl, C₁-C₆alkoxycarbonyl-C₁-C₆alkylsulfonyl-C₁-C₃alkyl, R₂₅SO₂N(R₂₄)—C₁-C₃alkyl, C₁-C₆alkylsulfonyloxy, C₁-C₆haloalkylsulfonyloxy, phenyl, benzyl, phenoxy, phenylthio, phenylsulfinyl, phenylsulfonyl, benzylthio, benzylsulfinyl or benzylsulfonyl, it being possible for the phenyl-containing groups to be substituted once, twice or three times by C₁-C₆alkyl, C₁-C₆haloalkyl, C₂-C₆alkenyl, C₂-C₆haloalkenyl, C₂-C₆-alkynyl, C₂-C₆haloalkynyl, C₁-C₆alkoxy, C₁-C₆haloalkoxy, C₃-C₆alkenyloxy, C₃-C₆alkynyloxy, C₁-C₆alkylthio, C₁-C₆haloalkylthio, C₃-C₆alkenylthio, C₃-C₆haloalkenylthio, C₃-C₆alkynylthio, C₁-C₄alkoxy-C₁-C₃alkylthio, C₁-C₄alkylcarbonyl-C₁-C₃alkylthio, C₁-C₄alkoxycarbonyl-C₁-C₃alkylthio, cyano-C₁-C₃alkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₂alkylaminosulfonyl, di(C₁-C₄alkyl)aminosulfonyl, C₁-C₃alkoxy-C₁-C₃alkyl, C₁-C₃alkoxycarbonyl-C₁-C₃alkyl, C₁-C₃alkylthio-C₁-C₃alkyl, C₁-C₃alkylsulfinyl-C₁-C₃alkyl, C₁-C₃alkylsulfonyl-C₁-C₃alkyl, NR₁₃R₁₄, halogen, cyano, nitro, phenyl or by phenyl-C₁-C₃alkyl which may be interrupted in the alkyl chain by oxygen or by —S(O)t-, and it being possible for phenyl-group-containing substituents themselves to be substituted on the phenyl ring by C₁-C₃alkyl, C₁-C₃haloalkyl, C₁-C₃alkoxy, C₁-C₃haloalkoxy, halogen, cyano or by nitro,
or R₂ is C₃-C₆cycloalkyl or phenyl, which is bonded to the group Q either directly or by way of a C₁-C₄alkylene chain which may be interrupted by oxygen or by —S(O)t-, it being possible for cycloalkyl to be substituted by C₁-C₃alkyl or by halogen and for phenyl to be substituted by C₁-C₃alkyl, C₁-C₃haloalkyl, C₁-C₃alkoxy, C₁-C₃haloalkoxy, halogen, cyano or by nitro;
or R₂ is a five- to ten-membered monocyclic or annellated bicyclic ring system which may be aromatic, partially saturated or fully saturated and may contain from 1 to 4 hetero atoms selected from nitrogen, oxygen and sulfur, or may be interrupted by a carbonyl group; the ring system being bonded to the group Q either directly or by way of a C₁-C₄alkylene chain which may be interrupted by oxygen or —S(O)t-, and wherein each ring system may contain no more than 2 oxygen atoms and no more than two sulfur atoms, and it being possible for the ring system itself to be substituted once, twice or three times by halogen, C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, C₁-C₆haloalkoxy, C₃-C₆alkenyloxy, C₃-C₆alkynyloxy, C₁-C₆alkylthio, C₁-C₆haloalkylthio, C₃-C₆alkenylthio, C₃-C₆haloalkenylthio, C₃-C₆alkynylthio, C₂-C₅alkoxyalkylthio, C₃-C₅acetylalkylthio, C₃-C₆alkoxycarbonylalkylthio, C₂-C₄cyanoalkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₄alkylaminosulfonyl, di(C₁-C₄alkyl)aminosulfonyl, R₂₀—C₁-C₃alkylene (wherein the alkylene chain may be interrupted by oxygen or by —S(O)t-), NR₁₃R₁₄, halogen, cyano, nitro or by phenyl, it being possible for phenyl itself to be substituted on the phenyl ring by C₁-C₃alkyl, C₁-C₃haloalkyl, C₁-C₃alkoxy, C₁-C₃haloalkoxy, halogen, cyano or by nitro, and wherein the substituents on the nitrogen in the heterocyclic ring do not contain halogen;
R₃ and R₈ are each independently of the other hydrogen, C₁-C₆alkyl, C₂-C₆alkenyl, C₂-C₆-alkynyl, C₁-C₆alkoxy, C₁-C₆alkyl-S(O)r-, C₁-C₆alkoxycarbonyl, C₁-C₆alkylcarbonyl, C₁-C₆alkyl-NHS(O)₂, C₁-C₆alkylamino, di(C₁-C₆alkyl)amino, hydroxy, C₁-C₆alkoxy, C₃-C₆alkenyloxy, C₃-C₆alkynyloxy, hydroxy-C₁-C₆alkyl, C₁-C₄alkylsulfonyloxy-C₁-C₆alkyl, tosyloxy-C₁-C₆alkyl, halogen, cyano, nitro, phenyl, or phenyl substituted by C₁-C₄alkyl, C₁-C₄haloalkyl, C₁-C₄-alkoxy, C₁-C₄haloalkoxy, C₁-C₄alkylcarbonyl, C₁-C₄alkoxycarbonyl, amino, C₁-C₄alkylamino, di(C₁-C₄alkyl)amino, C₁-C₄alkylthio, C₁-C₄alkylsulfinyl, C₁-C₄alkylsulfonyl, C₁-C₄alkylsulfonyloxy, C₁-C₄haloalkylthio, C₁-C₄haloalkylsulfinyl, C₁-C₄haloalkylsulfonyl, C₁-C₄haloalkylsulfonyloxy, C₁-C₄alkylsulfonylamino, N—(C₁-C₄alkyl)-C₁-C₄alkylsulfonylamino, halogen, nitro, COOH or by cyano;
or, when A₂ is C(R₅R₆)ₘ, R₈ forms, together with R₃, a direct bond or a C₁-C₃alkylene bridge;
R₄ and R₉ are each independently of the other hydrogen, C₁-C₄alkyl or C₁-C₄alkyl-S(O)r-;
or R₄ together with R₃, and/or R₉ together with R₈ are a C₂-C₆alkylene bridge which may be interrupted by —O— and/or —C(O)—, or by —S(O)v-;
R₅ is hydrogen, hydroxy, C₁-C₆alkyl, C₁-C₆haloalkyl, C₁-C₄hydroxyalkyl, C₁-C₄alkoxy-C₁-C₄alkyl, C₁-C₄alkylthio-C₁-C₄alkyl, C₁-C₄alkylthio-C₃-C₆cycloalkyl, C₁-C₄alkylcarbonyloxy-C₁-C₄alkyl, C₁-C₄alkylsulfonyloxy-C₁-C₄alkyl, tosyloxy-C₁-C₄alkyl, di(C₁-C₄alkoxy)-C₁-C₄alkyl, C₁-C₄alkoxycarbonyl, di(C₁-C₃alkylthio)-C₁-C₄alkyl, (C₁-C₃alkoxy)-(C₁-C₃alkylthio)-C₁-C₄alkyl, C₃-C₅oxacycloalkyl, C₃-C₅thiacycloalkyl, C₃-C₄dioxacycloalkyl, C₃-C₄dithiacycloalkyl, C₃-C₄-oxathiacycloalkyl, formyl, C₁-C₄alkoxyiminomethylene, carbamoyl, C₁-C₄alkylaminocarbonyl, di(C₁-C₄alkyl)aminocarbonyl, phenylaminocarbonyl, benzylaminocarbonyl or phenyl, it being possible for the phenyl-containing groups themselves to be substituted by C₁-C₄alkyl, C₁-C₄haloalkyl, C₁-C₄alkoxy, C₁-C₄haloalkoxy, C₁-C₄alkylcarbonyl, C₁-C₄alkoxycarbonyl, amino, C₁-C₄alkylamino, di(C₁-C₄alkyl)amino, C₁-C₄alkylthio, C₁-C₄alkylsulfinyl, C₁-C₄alkylsulfonyl, C₁-C₄alkylsulfonyloxy, C₁-C₄haloalkylthio, C₁-C₄haloalkylsulfinyl, C₁-C₄haloalkylsulfonyl, C₁-C₄haloalkylsulfonyloxy, C₁-C₄alkylsulfonylamino, N—(C₁-C₄alkyl)-C₁-C₄alkylsulfonylamino, halogen, nitro, COOH or by cyano;
or R₅ forms, together with R₃, R₄, R₈ or R₉, a direct bond or a C₁-C₄alkylene bridge or, when
m is 2, two groups R₅ together may be a direct bond;
R₆ is hydrogen, C₁-C₄alkyl or C₁-C₄haloalkyl;
R₇ is hydrogen, C₁-C₆alkyl, C₁-C₆haloalkyl, C₁-C₄alkoxycarbonyl, C₁-C₄alkylcarbonyl or di(C₁-C₄alkyl)aminocarbonyl, or phenyl which itself may be substituted by C₁-C₄alkyl, C₁-C₄haloalkyl, C₁-C₄alkoxy, C₁-C₄haloalkoxy, C₁-C₄alkylcarbonyl, C₁-C₄alkoxycarbonyl, C₁-C₄alkylamino, di(C₁-C₄alkyl)amino, C₁-C₄alkylthio, C₁-C₄alkylsulfinyl, C₁-C₄alkylsulfonyl, C₁-C₄alkylsulfonyloxy, C₁-C₄haloalkylthio, C₁-C₄haloalkylsulfinyl, C₁-C₄haloalkylsulfonyl, C₁-C₄haloalkylsulfonyloxy, C₁-C₄alkylsulfonylamino, N—(C₁-C₄alkyl)-C₁-C₄alkylsulfonylamino, halogen, nitro or by cyano;
R₁₀ and R₂₃ are each independently of the other hydrogen or C₁-C₆alkyl;
R₁₁ is halogen, C₁-C₆alkyl, C₁-C₆haloalkyl, C₂-C₆alkenyl, C₂-C₆haloalkenyl, C₂-C₆alkynyl, C₂-C₆haloalkynyl, C₁-C₆alkoxy, C₁-C₆haloalkoxy, C₃-C₆alkenyloxy, C₃-C₆alkynyloxy, C₁-C₆alkylthio, C₁-C₆haloalkylthio, C₃-C₆alkenylthio, C₃-C₆haloalkenylthio, C₃-C₆alkynylthio, C₁-C₄alkoxy-C₁-C₂alkylthio, C₁-C₄alkylcarbonyl-C₁-C₂alkylthio, C₁-C₄alkoxycarbonyl-C₁-C₂alkylthio, cyano-C₁-C₄alkylthio, C₁-C₆alkylsulfinyl, C₁-C₆haloalkylsulfinyl, C₁-C₆alkylsulfonyl, C₁-C₆haloalkylsulfonyl, aminosulfonyl, C₁-C₄alkylaminosulfonyl, di(C₁-C₄alkyl)aminosulfonyl, R₂₀—C₁-C₃alkylene (wherein the alkylene chain may be interrupted by oxygen or by —S(O)t-), NR₁₃R₁₄, halogen, cyano, nitro or phenyl, it being possible for phenyl itself to be substituted on the phenyl ring once, twice or three times by C₁-C₃alkyl, C₁-C₃haloalkyl, C₁-C₃alkoxy, C₁-C₃haloalkoxy, halogen, cyano or by nitro;
X₁ and X₂ are each independently of the other oxygen, di-C₁-C₄alkoxy or NR₁₂;
R₁₂ is hydroxy or C₁-C₄alkoxy;
R₁₃, R₁₄, R₁₅, R₁₆ and R₁₇ are each independently of the others C₁-C₁₂alkyl;
or R₁₃ and R₁₄ and/or R₁₆ and R₁₇, together with the nitrogen atom to which they are bonded, form a 3- to 7-membered ring which may be interrupted by —O—, —NR₇ or by —S(O)w-;
R₁₈ and R₂₄ are each independently of the other hydrogen, C₁-C₆alkyl, C₂-C₆alkenyl, C₂-C₆alkynyl, C₁-C₆haloalkyl, C₁-C₄alkoxy-C₁-C₂alkyl, phenyl or benzyl, it being possible for the phenyl-containing radicals to be substituted one or more times by halogen, C₁-C₄alkyl, C₁-C₂haloalkyl, C₁-C₂alkoxy, C₁-C₂haloalkoxy or by nitro;
or R₁₈ together with R₁₉ or R₂₄ together with R₂₅ form a 4- to 7-membered ring which may be substituted by C₁-C₃alkyl or interrupted by —O—, —NR₂₃—, —S(O)u- or by —C(X₁)—;
R₁₉ and R₂₅ are each independently of the other as defined for R;
R₂₀ is C₁-C₆alkoxy, C₁-C₃alkoxy-C₁-C₃alkoxy, C₁-C₄alkoxycarbonyl, C₁-C₆alkylthio, C₁-C₆alkylsulfinyl, C₁-C₆alkylsulfonyl or phenyl, it being possible for phenyl to be substituted by C₁-C₃alkyl, C₁-C₃haloalkyl, C₁-C₃alkoxy, C₁-C₃haloalkoxy, halogen, cyano or by nitro;
R₂₁, and R₂₂ are each independently of the other hydrogen, C₁-C₆alkyl, C₁-C₆haloalkyl, C₃-C₆alkenyl, C₃-C₆alkynyl, C₁-C₆alkoxy, benzyl or phenyl, it being possible for benzyl or phenyl itself to be substituted by C₁-C₄alkyl, C₁-C₄haloalkyl, C₁-C₄alkoxy, C₁-C₄haloalkoxy, C₁-C₄alkylcarbonyl, C₁-C₄alkoxycarbonyl, C₁-C₄alkylthio, C₁-C₄alkylsulfinyl, C₁-C₄alkylsulfonyl, C₁-C₄haloalkylthio, C₁-C₄haloalkylsulfinyl, C₁-C₄haloalkylsulfonyl, halogen, nitro or by cyano;
and to the agrochemically acceptable salts and all stereoisomers and tautomers of the compounds of formula I.

2. A compound of formula I according to claim 1, wherein either Q is a phenyl group substituted from one to four times by identical or different R₂ substituents, it being possible for the phenyl group also to include a further fused-on, saturated or unsaturated, 5- to 8-membered ring system which may be interrupted once, twice or three times by —O—, —NR₁₀—, —S(O)p- or by —C(X₂)— and substituted from one to three times by R₁₁; or Q is a pyridyl, pyridyl-N-oxido- or pyrimidinyl group substituted from one to three times by identical or different R₂ substituents or is a 5-membered heteroaryl group substituted from one to three times by R₂; and A₁ is C(R₃R₄) or NR₂₁; A₂ is C(R₅R₆)ₘ, C(O), oxygen, NR₇ or S(O)q, and A₃ is C(R₈R₉) or NR₂₂; with the proviso that A₂ is other than NR₇ or S(O)q, when A₁ is NR₂₁ and/or A₃ is NR₂₂.

3. A compound of formula I according to claim 1, wherein R is C₁-C₄alkyl, phenyl or benzyl, and R₁ is C₁-C₄alkoxy-C₁-C₂alkyl or benzyl.

4. A compound of formula Ie 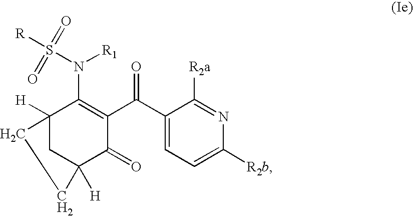
wherein R is C₁-C₄alkyl, phenyl or benzyl, R₁ is C₁-C₄alkoxy-C₁-C₂alkyl or benzyl, R₂a is C₁-C₃alkyl, fluoromethyl, difluoromethyl, trifluoromethyl, C₁-C₃alkoxy-C₁-C₄alkyl or C₁-C₄alkoxy-C₁-C₄alkoxy-C₁-C₄alkyl, and R₂b is difluoromethyl, difluorochloromethyl or trifluoromethyl.

5. A process for the preparation of a compound of formula I according to claim 1 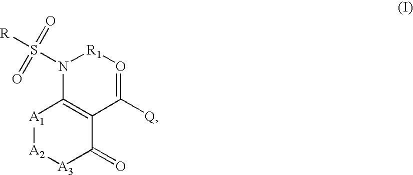
wherein R, R₁, Q, A₁, A₂ and A₃ are as defined in claim 1, which process comprises reacting a compound of formula II 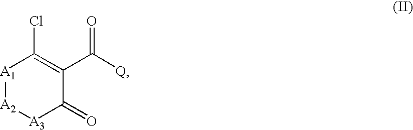
wherein Q, A₁, A₂ and A₃ are as defined in claim 1, wit h a sulfonamide of formula III
NHR₁SO₂R (III),
or with a salt of formula IIIa
M⁺⁻NR₁SO₂R (IIIa),
wherein R is as defined in claim 1 and M⁺ is an alkaline earth metal cation or an alkali metal cation.

6. A herbicidal and plant-growth-inhibiting composition comprising a herbicidally effective amount of a compound of formula I according to claim 1 on an inert carrier.

7. A method of controlling undesired plant growth, which method comprises applying a compound of formula I according to claim 1, or a composition comprising such a compound, in a herbicidally effective amount to the plants or to the locus thereof.

8. A method of inhibiting plant growth, which method comprises applying a compound of formula I according to claim 1, or a composition comprising such a compound, in an amount effective for inhibition of plant growth, to the plants or to the locus thereof.

9. Use of a composition according to claim 6 in controlling undesired plant growth.
